(19) United States
(12) Patent Application Publication
(10) Pub. No.: US 2026/0140512 A1
(43) Pub. Date: May 21, 2026

(54) CLEANING APPARATUS AND METHOD FOR CONTROLLING THE SAME

(71) Applicant: Samsung Electronics Co., Ltd., Suwon-si (KR)

(72) Inventors: Jeayun SO, Suwon-si (KR); Hyounsoo KIM, Suwon-si (KR); Minro YUN, Suwon-si (KR); Woojin NA, Suwon-si (KR); Hyungjoon KIM, Suwon-si (KR); Kyoungwoung KIM, Suwon-si (KR)

(21) Appl. No.: 19/429,101

(22) Filed: Dec. 22, 2025

Related U.S. Application Data
(63) Continuation of application No. PCT/KR2025/095705, filed on Nov. 12, 2025.

(30) Foreign Application Priority Data
Nov. 15, 2024 (KR) 10-2024-0163603

(51) Int. Cl. G05D 1/648; A46B 13/00; A46B 13/02; A46B 15/00; A47L 9/00; A47L 9/04; A47L 9/08; A47L 9/28; A47L 11/283; A47L 11/40; G05D 1/246; G05D 105/10; G05D 111/10; G06V 20/56

(52) U.S. Cl. CPC G05D 1/6486; A46B 13/001; A46B 13/02; A46B 15/0004; A47L 9/0063; A47L 9/009; A47L 9/0405; A47L 9/0472; A47L 9/0477; A47L 9/0494; A47L 9/08; A47L 9/281; A47L 9/2852; A47L 11/283; A47L 11/4011; A47L 11/4038; A47L 11/4041; A47L 11/4055; A47L 11/4061; A47L 11/4069; A47L 11/4091; G05D 1/2469; G06V 20/56; A46B 2200/3033; A47L 2201/028; A47L 2201/04; G05D 2105/10; G05D 2111/10; G06V 2201/07

(57) ABSTRACT

A cleaning apparatus is provided. The cleaning apparatus includes a robot cleaner including a brush configured to scatter dirt by scrubbing a surface to be cleaned and a mop configured to clean the surface to be cleaned by contacting the surface to be cleaned, and a station on which the robot cleaner is placeable, wherein the robot cleaner further includes an air jet device configured to spray air onto the surface to be cleaned, a camera configured to obtain an image of the surface to be cleaned, memory, including one or more storage media, storing instructions, and a processor communicatively coupled to the air jet device, the camera, and the memory, wherein the instructions, when executed by the processor, cause the robot cleaner to determine to spray air onto the surface to be cleaned through the air jet device based on the image obtained from the camera, and identify a target object as liquid based on a shape change of the target object included in consecutive images obtained from the camera while the air jet device sprays air onto the surface to be cleaned.

### CROSS-REFERENCE TO RELATED APPLICATION(S)

This application is a continuation application, claiming priority under 35 U.S.C. § 365(c), of an International application No. PCT/KR 2025/095705, filed on Nov. 12, 2025, which is based on and claims the benefit of a Korean patent application number 10-2024-0163603, filed on Nov. 15, 2024, in the Korean Intellectual Property Office, the disclosure of which is incorporated by reference herein in its entirety.

### BACKGROUND

### 1. Field

The disclosure relates to a cleaning apparatus that detects liquid on a surface to be cleaned, and a method for controlling the same.

### 2. Description of Related Art

In general, a robot cleaner is a device that moves across a cleaning area and automatically cleans the cleaning area by vacuuming dirt and other debris from the floor without user operation. The robot cleaner cleans the area while moving across the cleaning area.

The robot cleaner uses a distance sensor to determine a distance to obstacles, such as furniture, office equipment, and walls in the cleaning area, and changes direction to clean the cleaning area by selectively driving the left and right wheel motors of the robot cleaner.

Existing robot cleaners use cameras to detect, avoid, or clean liquid in their path. However, the detection performance is affected by the lighting, floor pattern, and floor color of the cleaning area.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a cleaning apparatus that includes an air jet device configured to spray air onto a surface to be cleaned, obtains an image of the surface to be cleaned from a camera, and detects liquid on the surface to be cleaned based on a shape change of a target object in the image, and a method for controlling the same.

Additional aspects will be set forth in part in the description which follows and, in part, will be apparent from the description, or may be learned by practice of the presented embodiments.

In accordance with an aspect of the disclosure, a cleaning apparatus is provided. The cleaning apparatus includes a robot cleaner including a brush configured to scatter dirt by scrubbing a surface to be cleaned and a mop configured to clean the surface to be cleaned by contacting the surface to be cleaned, and a station on which the robot cleaner is placeable, wherein the robot cleaner further includes an air jet device configured to spray air onto the surface to be cleaned, a camera configured to obtain an image of the surface to be cleaned, and a processor configured to determine to spray air onto the surface to be cleaned through the air jet device based on the image obtained from the camera, and identify a target object as liquid based on a shape change of the target object included in consecutive images obtained from the camera while the air jet device sprays air onto the surface to be cleaned.

In accordance with another aspect of the disclosure, a cleaning apparatus is provided. The cleaning apparatus includes a robot cleaner including a brush configured to scatter dirt by scrubbing a surface to be cleaned and a mop configured to clean the surface to be cleaned by contacting the surface to be cleaned, and a station on which the robot cleaner is placeable, wherein the robot cleaner further includes an air jet device configured to spray air onto the surface to be cleaned, a camera configured to obtain an image of the surface to be cleaned, memory, including one or more storage media, storing instructions, and a processor communicatively coupled to the air jet device, the camera, and the memory, wherein the instructions, when executed by the processor, cause the robot cleaner to determine to spray air onto the surface to be cleaned through the air jet device based on the image obtained from the camera, and identify a target object as liquid based on a shape change of the target object included in consecutive images obtained from the camera while the air jet device sprays air onto the surface to be cleaned.

In accordance with another aspect of the disclosure, a method for controlling a cleaning apparatus including a robot cleaner including a brush configured to scatter dirt by scrubbing a surface to be cleaned, a mop configured to clean the surface to be cleaned by contacting the surface to be cleaned, an air jet device configured to spray air onto the surface to be cleaned, and a camera configured to obtain an image of the surface to be cleaned, and a station on which the robot cleaner is placeable is provided. The method includes determining to spray air onto the surface to be cleaned through the air jet device based on the image obtained from the camera, spraying, by the air jet device, air onto the surface to be cleaned, obtaining, by the camera, consecutive images of the surface to be cleaned while air is sprayed onto the surface to be cleaned, and identifying a target object as liquid based on a shape change of the target object included in the consecutive images obtained from the camera.

In accordance with another aspect of the disclosure, one or more non-transitory computer-readable storage media storing one or more computer programs including computer-executable instructions that, when executed by one or more processors of a cleaning apparatus individually or collectively, cause the cleaning apparatus to perform operations, the cleaning apparatus comprising a robot cleaner comprising a brush configured to scatter dirt by scrubbing a surface to be cleaned, a mop configured to clean the surface to be cleaned by contacting the surface to be cleaned, an air jet device configured to spray air onto the surface to be cleaned, and a camera configured to obtain an image of the surface to be cleaned; and a station on which the robot cleaner is placeable are provided. The operations include determining to spray air onto the surface to be cleaned through the air jet device based on the image obtained from the camera, spraying, by the air jet device, air onto the surface to be cleaned, obtaining, by the camera, consecutive images of the surface to be cleaned while air is sprayed onto the surface to be cleaned, and identifying a target object as liquid based on a shape change of the target object included in the consecutive images obtained from the camera.

The cleaning apparatus and the method for controlling the same improve liquid detection performance on a surface to be cleaned.

The cleaning apparatus and the method for controlling the same accurately detect liquid on a surface to be cleaned, and control components of the cleaning apparatus according to a current cleaning mode, thereby improving cleaning efficiency and preventing re-contamination by the liquid.

The cleaning apparatus and the method for controlling the same control components of the cleaning apparatus according to characteristics of a cleaning area, a user, or a surface to be cleaned, thereby improving cleaning efficiency and preventing re-contamination by the liquid.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network system implemented by various electronic devices according to an embodiment of the disclosure;

FIG. 2 illustrates a state in which a robot cleaner is away from a station in a cleaning apparatus according to an embodiment of the disclosure;

FIG. 3 illustrates a state in which a robot cleaner is seated on a station in a cleaning apparatus according to an embodiment of the disclosure;

FIG. 4 illustrates a rear portion of a robot cleaner according to an embodiment of the disclosure;

FIG. 5 illustrates a front portion of a robot cleaner according to an embodiment of the disclosure;

FIG. 6 illustrates a lower portion of a robot cleaner according to an embodiment of the disclosure;

FIG. 7 illustrates an internal configuration of a robot cleaner from a rear according to an embodiment of the disclosure;

FIG. 8 is a control block diagram of a robot cleaner according to an embodiment of the disclosure;

FIG. 9 illustrates a robot cleaner moving forward and spraying air forward through an air jet device over time according to an embodiment of the disclosure;

FIG. 10 illustrates consecutive images obtained while a robot cleaner of FIG. 9 sprays air forward according to an embodiment of the disclosure;

FIG. 11 illustrates a preset operation of a robot cleaner when liquid is detected during a dry cleaning mode according to an embodiment of the disclosure;

FIG. 12 illustrates a preset operation of a robot cleaner when liquid is detected during a wet cleaning mode according to an embodiment of the disclosure;

FIG. 13 illustrates a preset operation of a robot cleaner when liquid is detected during a dry-and-wet cleaning mode according to an embodiment of the disclosure;

FIG. 14 illustrates that a robot cleaner performs intensive liquid cleaning according to an embodiment of the disclosure;

FIG. 15 illustrates a cleaning map and a cleaning area according to an embodiment of the disclosure;

FIG. 16 illustrates a path for a robot cleaner to return to a station after performing intensive liquid cleaning according to an embodiment of the disclosure;

FIG. 17 illustrates a path for a robot cleaner to move to resume cleaning after returning to a station and performing mop washing according to an embodiment of the disclosure;

FIG. 18 illustrates a path for a robot cleaner to move to resume cleaning after returning to a station and performing mop washing according to an embodiment of the disclosure;

FIG. 19 is a flowchart illustrating a method for controlling a robot cleaner according to an embodiment of the disclosure;

FIG. 20 is a flowchart illustrating preset operations performed according to a cleaning mode after a robot cleaner detects liquid according to an embodiment of the disclosure;

FIG. 21 is a flowchart illustrating operations of a robot cleaner according to a cleaning area where liquid is detected according to an embodiment of the disclosure;

FIG. 22 is a flowchart illustrating operations of a robot cleaner according to characteristics of a surface to be cleaned according to an embodiment of the disclosure; and

FIG. 23 is a flowchart illustrating operations of a robot cleaner according to a user's behavior pattern according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

Terms, such as “1^{st}”, “2^{nd}”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

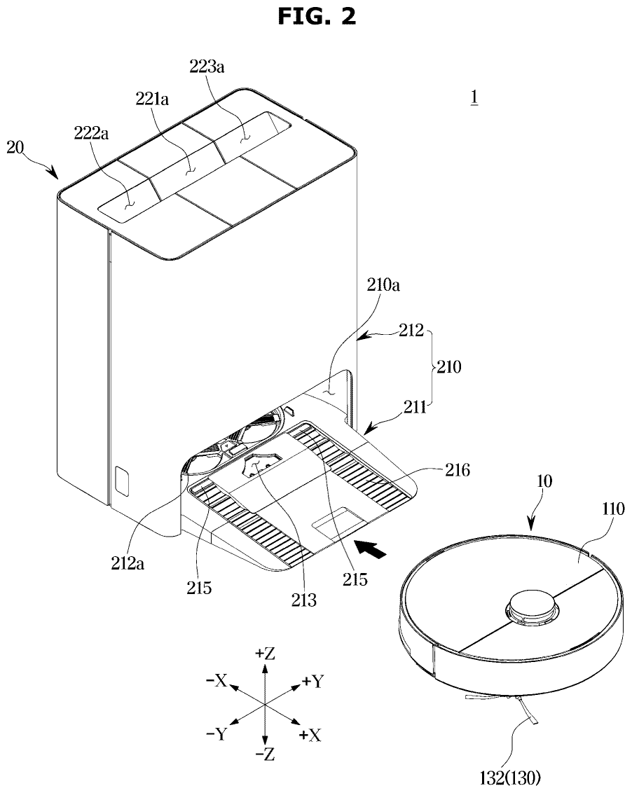

The terms “front,” “rear,” “left,” “right,” “upper,” “lower,” or the like, used in the following description are defined based on the drawings, and the shape and position of each component are not limited by these terms. For example, as shown in FIG. 2, a direction in which a robot cleaner 10 enters a station 20 may be defined as the rear (−X direction), and an opposite direction may be defined as the front (+X direction).

Hereinafter, the principles of operation and embodiments of the disclosure will be described with reference to the accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

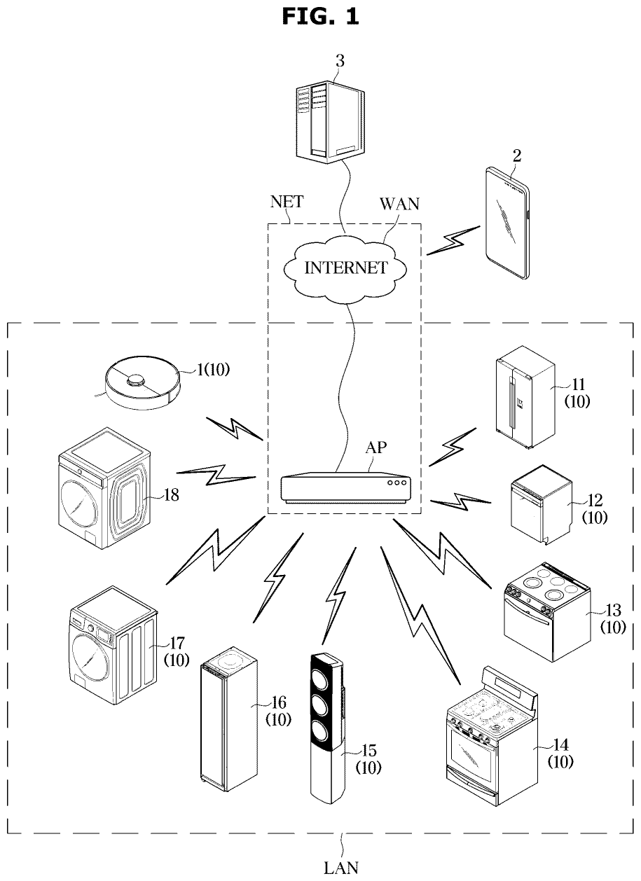

FIG. 1 illustrates a network system implemented by various electronic devices according to an embodiment of the disclosure.

Referring to FIG. 1, a home appliance 100 may include a communication module capable of communicating with another home appliance, a user device 2, or a server 3, a user interface that receives a user input or outputs information to a user, at least one processor that controls an operation of the home appliance 100, and at least one memory that stores a program for controlling the operation of the home appliance 100.

The home appliance 100 may be at least one of various types of home appliances. For example, as shown in the accompanying drawings, the home appliance 100 may include at least one of a refrigerator 11, a dishwasher 12, an electric range 13, an electric oven 14, an air conditioner 15, a clothes treating apparatus 16, a washing machine 17, a dryer 18, or a cleaning apparatus 1.

However, the home appliance 100 is not limited to the examples shown in FIG. 1. For example, the home appliance 100 may include various types of appliances not shown in the drawings, such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the home appliance 100 according to an embodiment.

The server 3 may include a communication module communicating with another server, the home appliance 100, or the user device 2, at least one processor that processes data received from another server, the home appliance 100, or the user device 2, and at least one memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 100 in association with the user account, managing or controlling the registered home appliance 100, and the like. For example, a user may access the server 3 via the user device 2 and may create a user account. The user account may be identified by an identifier (ID) and a password set by the user. The server 3 may register the home appliance 100 with the user account according to a predetermined procedure. For example, the server 3 may link identification information of the home appliance 100 (e.g., a serial number or medium access control (MAC) address) to the user account to register, manage, and control the home appliance 100. The user device 2 may include a communication module capable of communicating with the home appliance 100 or the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program for controlling the home appliance 100, i.e., an application. The application may be sold installed on the user device 2, or may be downloaded from an external server for installation.

By running the application installed on the user device 2 by a user, the user may access the server 3, create a user account, and communicate with the server 3 based on the login user account to register the home appliance 100.

For example, by operating the home appliance 100 to allow the home appliance 100 to access the server 3 according to a procedure guided by the application installed on the user device 2, the server 3 may register the home appliance 100 with the user account by assigning the identification information (e.g., a serial number or a MAC address) of the home appliance 100 to the corresponding user account.

A user may control the home appliance 100 using the application installed on the user device 2. For example, by logging into a user account with the application installed on the user device 2, the home appliance 100 registered in the user account appears, and by inputting a control command for the home appliance 100, the control command may be delivered to the home appliance 100 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth™(IEEE 802.15.1), Zigbee (IEEE 802.15.4), Wi-Fi Direct, near field communication (NFC), and Z-Wave, but is not limited thereto.

The AP may connect the home appliance 100 or the user device 2 to a WAN connected to the server 3. The home appliance 100 or the user device 2 may be connected to the server 3 via a WAN.

The AP may communicate with the home appliance 100 or the user device 2 using wireless communication, such as Wi-Fi™(IEEE 802.11), Bluetooth™(IEEE 802.15.1), Zigbee (IEEE 802.15.4), and the like, and access a WAN using wired communication, but is not limited thereto.

According to various embodiments of the disclosure, the home appliance 100 may be directly connected to the user device 2 or the server 3 without going through an AP.

The home appliance 100 may be connected to the user device 2 or the server 3 via a long-range wireless network or a short-range wireless network.

For example, the home appliance 100 may be connected to the user device 2 via a short-range wireless network (e.g., Wi-Fi Direct).

In another example, the home appliance 100 may be connected to the user device 2 or the server 3 via a WAN using a long-range wireless network (e.g., a cellular communication module).

In still another example, the home appliance 100 may access a WAN using wired communication, and may be connected to another home appliance 100 or the server 3 via a WAN.

When accessing a WAN using wired communication, the home appliance 100 may also act as an AP. Accordingly, the home appliance 100 may connect another home appliance 100 to a WAN to which the server 3 is connected. In addition, another home appliance 100 may connect the home appliance 100 to the WAN to which the server 3 is connected.

The home appliance 100 may transmit information about an operation or state to other home appliances, the user device 2, or the server 3 via the network. For example, the home appliance 100 may transmit information about an operation or state to other home appliances, the user device 2 or the server 3 upon receiving a request from the server 3, in response to an event in the home appliance 100, or periodically or in real time. Upon receiving the information about the operation or state from the home appliance 100, the server 3 may update the stored information about the operation or state of the home appliance 100 and transmit the updated information about the operation and state of the home appliance 100 to the user device 2 via the network. Here, updating the information may include various operations in which existing information is changed, such as adding new information to the existing information, replacing the existing information with new information, and the like.

The home appliance 100 may obtain various information from other home appliances, the user device 2, or the server 3, and may provide the obtained information to a user. For example, the home appliance 100 may obtain information related to a function of the home appliance 100 (e.g., recipes, washing instructions, or the like) from the server 3 and various environmental information (e.g., weather, temperature, humidity, or the like), and may output the obtained information via a user interface.

The home appliance 100 may operate in accordance with a control command received from other home appliances, the user device 2, or the server 3. For example, the home appliance 100 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 100 or the server 3 via the communication module. For example, the user device 2 may transmit information about a user's location, a user's health condition (i.e., state), a user's preference, a user's schedule, and the like to the server 3. The user device 2 may transmit information about the user to the server 3 based on the user's prior authorization.

The home appliance 100, the user device 2, or the server 3 may use techniques, such as artificial intelligence (AI) to determine a control command. For example, the server 3 may receive information about an operation or a state of the home appliance 100 or information about a user of the user device 2, process the received information using techniques, such as AI, and transmit a processing result or a control command to the home appliance 100 or the user device 2 based on the processing result.

FIG. 2 illustrates a state in which a robot cleaner is away from a station in a cleaning apparatus according to an embodiment of the disclosure.

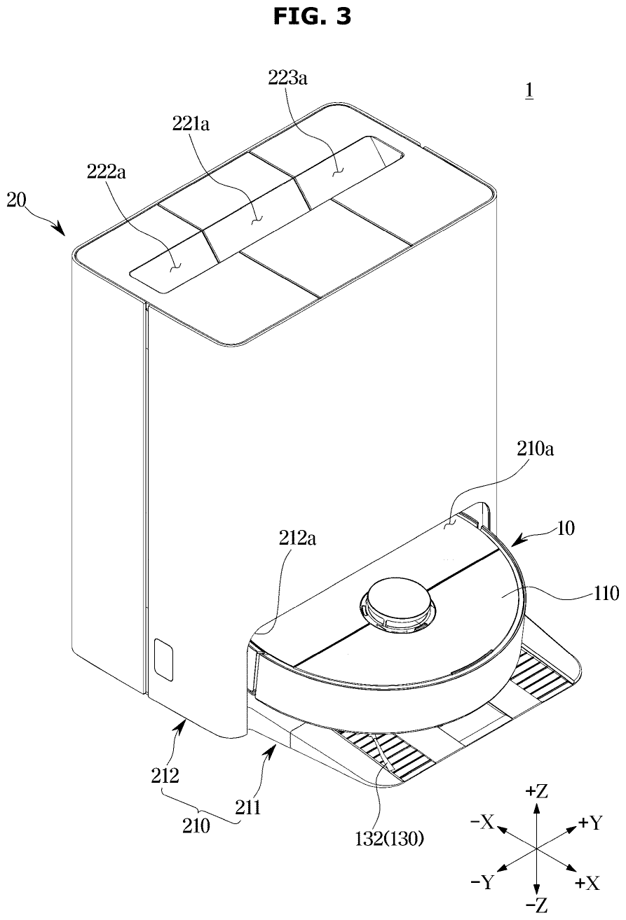

FIG. 3 illustrates a state in which a robot cleaner is seated on a station in a cleaning apparatus according to an embodiment of the disclosure.

Referring to FIGS. 2 and 3, the cleaning apparatus 1 may include a robot cleaner 10 and a station 20. The cleaning apparatus 1 may be referred to as the cleaning apparatus 1.

The robot cleaner 10 may clean a floor while moving across the floor. The floor cleaned by the robot cleaner 10 may be referred to as a surface to be cleaned (surface being cleaned). The robot cleaner 10 may perform dry cleaning and/or wet cleaning. The robot cleaner 10 may draw in (pick up) or wipe away dirt on the surface to be cleaned. Here, the term “dirt” may refer to foreign substances, such as dust, hair, food particles, and the like.

The robot cleaner 10 may be seated on the station 20. The robot cleaner 10 may be placed on the station 20. The robot cleaner 10 may be docked to the station 20. At least a portion of the robot cleaner 10 may be positioned in a receiving space 210a of the station 20.

The robot cleaner 10 may move to the station 20 during cleaning and/or after completion of the cleaning. For example, the robot cleaner 10 may return to the station 20.

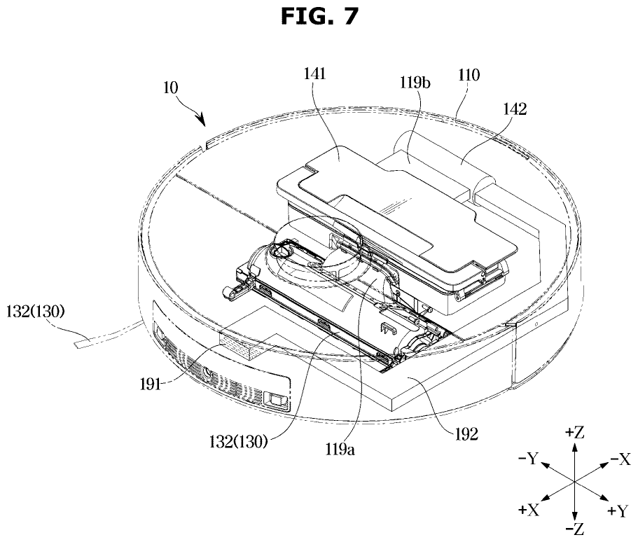

For example, the robot cleaner 10 may move to the station 20 in a case where recharging is required, in a case where dirt in a dust bin 141 (see FIG. 7) requires to be emptied, in a case where moisture content of a mop 160 is low, in a case where the mop 160 requires to be washed, in a case where the mop 160 requires to be sterilized, and/or in a case where the mop 160 requires to be dried.

The station 20 may be configured such that the robot cleaner 10 is placeable. The station 20 may be configured such that the robot cleaner 10 may be seated. The station 20 may be configured to store the robot cleaner 10.

For example, while the robot cleaner 10 is seated on the station 20, the station 20 may charge a battery (not shown) of the robot cleaner 10. For example, while the robot cleaner 10 is seated on the station 20, the station 20 may collect the dirt collected in the dust bin 141 of the robot cleaner 10. For example, while the robot cleaner 10 is seated on the station 20, the station 20 may supply water to a water tank (not shown) of the robot cleaner 10. For example, while the robot cleaner 10 is seated on the station 20, the station 20 may wet the mop 160 with water and/or steam. For example, while the robot cleaner 10 is seated on the station 20, the station 20 may wash the mop 160. For example, while the robot cleaner 10 is seated on the station 20, the station 20 may sterilize the mop 160. For example, while the robot cleaner 10 is seated on the station 20, the station 20 may dry the mop 160.

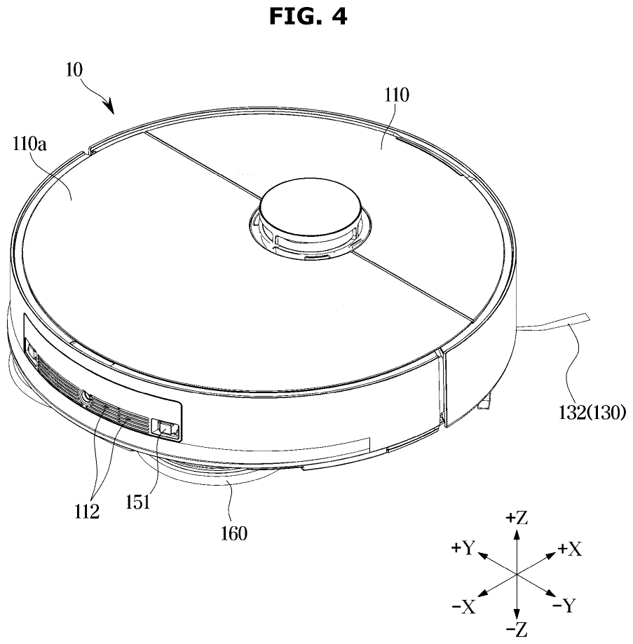

FIG. 4 illustrates a rear portion of a robot cleaner according to an embodiment of the disclosure.

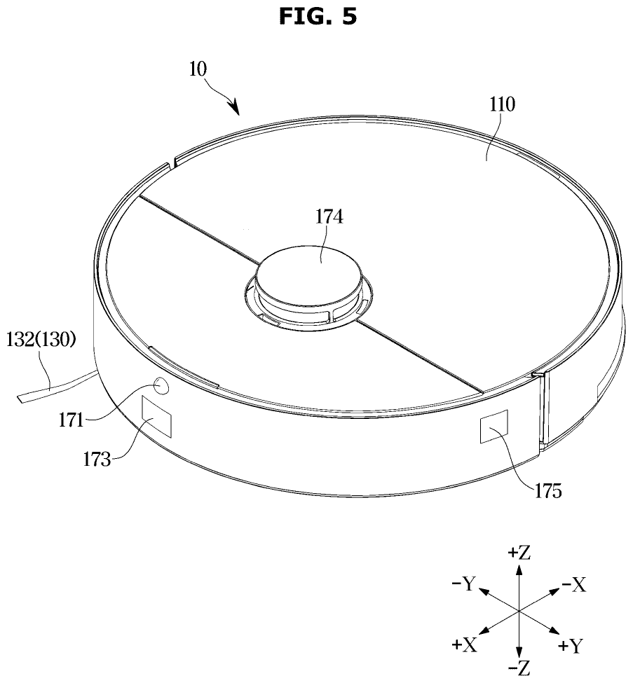

FIG. 5 illustrates a front portion of a robot cleaner according to an embodiment of the disclosure.

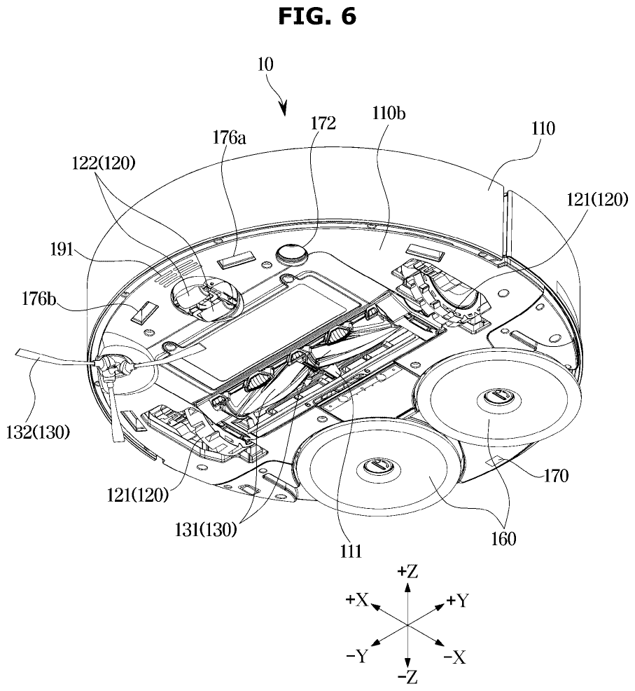

FIG. 6 illustrates a lower portion of a robot cleaner according to an embodiment of the disclosure.

FIG. 7 illustrates an internal configuration of a robot cleaner from a rear according to an embodiment of the disclosure.

Referring to FIGS. 4, 5, 6, and 7, the robot cleaner 10 may include a main body 110. The main body 110 may form an overall exterior of the robot cleaner 10. Components of the robot cleaner 10 may be accommodated in the main body 110. Electronic components may be disposed in the main body 110. The main body 110 may be referred to as the robot cleaner main body 110.

The robot cleaner 10 may include an inlet 111. The inlet 111 may be formed to face a surface to be cleaned. The inlet 111 may be open to the surface to be cleaned. The inlet 111 may be formed in the main body 110. For example, the inlet 111 may be formed in a lower portion of the main body 110. The inlet 111 may be formed through a lower side 110b of the main body 110. Dirt on the surface to be cleaned may be drawn into the main body 110 through the inlet 111 together with air. The inlet 111 may be referred to as the robot cleaner inlet 111.

The robot cleaner 10 may include a brush 130. The brush 130 may scatter dirt by scrubbing the surface to be cleaned. Dirt scattered by the brush 130 may flow into the inlet 111 together with air.

For example, the robot cleaner 10 may include a first brush 131 disposed in the inlet 111. The first brush 131 may be rotatably mounted with respect to the main body 110. A rotation axis of the first brush 131 may be an axis extending along a substantially horizontal direction (Y direction). The first brush 131 may be referred to as the first brush 131.

For example, the robot cleaner 10 may include a second brush 132 disposed adjacent to a lower edge of the main body 110. The second brush 132 may direct, to the inlet 111, dirt around the main body 110 where the first brush 131 may not sweep. The second brush 132 may be rotatably mounted with respect to the main body 110. A rotation axis of the second brush 132 may be an axis extending along a substantially vertical direction (Z direction). The second brush 132 may be referred to as the second brush 132. The robot cleaner 10 may include a side brush protrusion driver (not shown) that protrudes the second brush 132 out of a side of the robot cleaner 10. The processor 91 may control the side brush protrusion driver to allow the second brush 132 to protrude out of the side of the robot cleaner 10 when it is identified that the robot cleaner 10 is close to a wall or an obstacle based on information obtained from a plurality of sensors 171, 172, 173, 174, 175, and 176 (including 176a and 176b) included in a sensor portion 170.

The robot cleaner 10 may include the dust bin 141. Dirt and/or air drawn in through the inlet 111 may move to the dust bin 141. The dirt drawn in through the inlet 111 may be collected in the dust bin 141. The air drawn in through the inlet 111 may be filtered while passing through the dust bin 141. The dirt and air drawn in through the inlet 111 may be separated within the dust bin 141.

The robot cleaner 10 may include an outlet 112. The outlet 112 may be formed in the main body 110. The outlet 112 may be formed on a rear side of the main body 110. The air drawn in through the inlet 111 may be filtered and discharged to the outside of the robot cleaner 10 through the outlet 112. For example, a plurality of outlets 112 may be formed, and the plurality of outlets may be formed as a plurality of holes. The outlet 112 may be referred to as the robot cleaner outlet 112.

The robot cleaner 10 may include an intake motor 142. The intake motor 142 may generate suction force. Due to the suction force generated by the intake motor 142, dirt and/or air may be drawn in through the inlet 111. Due to the suction force generated by the intake motor 142, the air drawn into and filtered in the robot cleaner 10 may be discharged to the outside through the outlet 112. The intake motor 142 may be disposed in an air flow path 119 formed between the inlet 111 and the outlet 112. The intake motor 142 may be referred to as the robot cleaner intake motor 142.

The air flow path formed between the inlet 111 and the outlet 112 may include a first flow path 119a between the inlet 111 and the dust bin 141 and/or a second flow path 119b between the dust bin 141 and the outlet 112. Air containing dirt may move in the first flow path 119a. Air from which dirt has been separated by being filtered while passing through the dust bin 141 may move in the second flow path 119b.

The robot cleaner 10 may include an air discharge opening 191 by way of pathway 192. The air discharge opening 191 may be formed in the main body 110. The air discharge opening 191 may be formed on a rear side of the main body 110. However, the position of the air discharge opening 191 is not limited thereto, and any position that may spray air onto the surface to be cleaned may be adopted as the position of the air discharge opening 191. The air drawn in through the inlet 111 may be filtered and discharged to the outside of the robot cleaner 10 through the air discharge opening 191. For example, the air drawn in through the inlet 111 may be filtered, move to the air discharge opening 191 through a third flow path 119c branching from the second flow path 119b, and be sprayed onto the surface to be cleaned through the air discharge opening 191. A plurality of air discharge openings 191 may be provided, and the plurality of air discharge openings 191 may be formed as a plurality of holes.

The robot cleaner 10 may include the third flow path 119c. The third flow path 119c may branch from the second flow path 119b to move the filtered air toward the air discharge opening 191. For example, one end of the third flow path 119c may be connected to the second flow path 119b, and the other end may be connected to the air discharge opening 191.

According to various embodiments of the disclosure, the robot cleaner 10 may include an auxiliary intake motor (not shown). The auxiliary intake motor may generate suction force. Due to the suction force generated by the auxiliary intake motor, the filtered air may move to the air discharge opening 191. Accordingly, the robot cleaner 10 may spray air onto the surface to be cleaned with a stronger spray force. The structure and shape of the third flow path 119c are not limited thereto. In other words, any structure and shape that may move air to the air discharge opening 191 to spray contaminant-free air (e.g., filtered air) onto the surface to be cleaned through the air discharge opening 191 may be adopted as the structure and shape of the third flow path 119c.

The robot cleaner 10 may include a motion driver 120 for moving the robot cleaner 10. The motion driver 120 is mounted to the main body 110 and may move the main body 110. For example, the motion driver 120 may include a pair of main wheels 121. According to various embodiments of the disclosure, the motion driver 120 may further include at least one auxiliary wheel 122 to enable the robot cleaner 10 to travel stably.

The robot cleaner 10 may include a battery. The battery is rechargeable. The battery may provide power required to drive the robot cleaner 10.

The robot cleaner 10 may include a charging terminal 51. The charging terminal 51 may be electrically connected to the battery. While the robot cleaner 10 is seated on the station 20, the charging terminal 51 of the robot cleaner 10 may be electrically connected to a charging terminal of the station 20. Because the charging terminal 51 of the robot cleaner 10 may be electrically connected to the charging terminal of the station 20, the battery of the robot cleaner 10 may be charged. For example, while the robot cleaner 10 is docked at the station 20, the battery may be charged. The charging terminal 51 may be referred to as the robot cleaner charging terminal 51.

The robot cleaner 10 may include the mop 160. The mop 160 is detachably mountable to a lower portion of the main body 110. The mop 160 may be rotatably mounted with respect to the main body 110. The mop 160 may clean the surface to be cleaned by contacting the surface to be cleaned. In a state where the mop 160 is wet, the mop 160 may wipe away dirt on the surface to be cleaned. Although the two mops 160 are shown in the drawings, the number of mops 160 is not limited thereto. The mop 160 may be referred to as the mop 160. The mop 160 may be referred to as the wet pad.

The mop 160 may be supplied with moisture from a water tank (not shown) of the robot cleaner 10. The mop may be supplied with moisture from the station 20.

The robot cleaner 10 may include the sensor portion 170. In other words, the robot cleaner 10 may include a plurality of sensors 171, 172, 173, 174, 175, and 176. In other words, the sensor portion 170 may include a plurality of sensors 171, 172, 173, 174, 175, and 176.

The robot cleaner 10 may include a camera 171. The camera 171 may obtain visual information about the surrounding environment of the robot cleaner 10. For example, the camera 171 may obtain visual information about the surface to be cleaned. The camera 171 may be formed in the main body 110. The camera 171 may be formed on a side surface of the main body 110. However, the position of the camera 171 is not limited thereto, and any position that may obtain visual information about the surrounding environment of the robot cleaner 10 may be adopted as the position of the camera 171. The visual information obtained from the camera 171 may be transmitted to the processor 91. The camera 171 may be referred to as an image sensor.

The robot cleaner 10 may include a floor detection sensor 172. The floor detection sensor 172 may obtain information for identifying whether the surface to be cleaned with which the robot cleaner 10 is in contact corresponds to a soft floor or a hard floor. In this instance, the soft floor may include a carpet, a rug, or a rubber mat. The hard floor may include a wooden floor, a tile floor, or a concrete floor. The examples of the soft floor or the hard floor are not limited to the aforementioned examples, and a soft and cushiony floor surface may be included in the soft floor, and a floor surface made of a solid and hard material may be included in the hard floor.

For example, the floor detection sensor 172 may be a sensor that detects a change in surface resistance. Accordingly, the floor detection sensor 172 may obtain information about a change in resistance caused by a fibrous structure such as a carpet.

The floor detection sensor 172 may be formed in the main body 110. The floor detection sensor 172 may be formed on a rear surface of the main body 110. However, the position of the floor detection sensor 172 is not limited thereto, and any position that may obtain information about the surface to be cleaned with which the robot cleaner 10 is in contact may be adopted as the position of the floor detection sensor 172. The information obtained from the floor detection sensor 172 may be transmitted to the processor 91.

The robot cleaner 10 may include an obstacle detection sensor 173. An obstacle may refer to any object that protrudes from the floor of the cleaning area and obstructs the travel of the robot cleaner 10. For example, furniture, such as a table and a sofa located in the cleaning area, as well as a wall that partitions a space may correspond to an obstacle. An object that the robot cleaner 10 may climb over and descend, such as a threshold or a round bar, may also correspond to an obstacle. The obstacle detection sensor 173 may detect the position of an obstacle or the distance to an obstacle. For example, the obstacle detection sensor 173 may include an ultrasonic sensor or an infrared sensor. Accordingly, the obstacle detection sensor 173 may obtain information about the position of an obstacle or the distance to an obstacle by emitting an ultrasonic wave or infrared ray to the external surrounding environment of the robot cleaner 10 and receiving a signal reflected from the obstacle. The obstacle detection sensor 173 may be mounted on the main body 110. For example, the obstacle detection sensor 173 may be disposed on a side surface of the main body 110. According to various embodiments of the disclosure, the obstacle detection sensor 173 may protrude from the main body 110. However, the position of the obstacle detection sensor 173 is not limited thereto, and any position that may obtain information about an obstacle located around the robot cleaner 10 or on a moving path may be adopted as the position of the obstacle detection sensor 173. The information obtained from the obstacle detection sensor 173 may be transmitted to the processor 91.

The robot cleaner 10 may include a light detection and ranging (LiDAR) sensor 174. The LiDAR sensor 174 may obtain information about the surrounding environment of the robot cleaner 10. For example, the LiDAR sensor 174 may recognize a wall, an obstacle, or the like, around the robot cleaner 10 by emitting a laser and then receiving the reflected laser. In addition, the LiDAR sensor 174 may obtain distance data between various structures (e.g., walls, obstacles, or the like) and the robot cleaner 10 by measuring the time it takes for a laser to be reflected after being emitted. The LiDAR sensor 174 may be mounted on the main body 110. For example, the LiDAR sensor 174 may protrude from an upper surface 110a of the main body 110. However, the position of the LiDAR sensor 174 is not limited thereto, and any position that may obtain information about the surrounding environment from the laser reflected therefrom by emitting a laser to the surrounding environment of the robot cleaner 10 may be adopted as the position of the LiDAR sensor 174. The information obtained from the LiDAR sensor 174 may be transmitted to the processor 91.

The robot cleaner 10 may include a wall detection sensor 175. The wall detection sensor 175 may obtain information about a wall adjacent to the robot cleaner 10. For example, the wall detection sensor 175 may include an ultrasonic sensor or an infrared sensor. For example, the wall detection sensor 175 may recognize a wall around the robot cleaner 10 by emitting an ultrasonic wave or infrared ray toward the wall and then receiving the reflected ultrasonic or infrared signal. In addition, the wall detection sensor 175 may obtain distance data between the walls around the robot cleaner 10 and the robot cleaner 10 by measuring the time it takes for an ultrasonic wave or infrared ray to be reflected after being emitted. The wall detection sensor 175 may be mounted on the main body 110. For example, the wall detection sensor 175 may be disposed on a side surface of the main body 110. However, the position of the wall detection sensor 175 is not limited thereto, and any position that may obtain information about a wall adjacent to the robot cleaner 10 may be adopted as the position of the wall detection sensor 175. The information obtained from the wall detection sensor 175 may be transmitted to the processor 91.

The robot cleaner 10 may include a cliff detection sensor 176. The cliff detection sensor 176 may obtain information for recognizing a step on the surface to be cleaned. For example, the cliff detection sensor 176 may include an infrared sensor. For example, the cliff detection sensor 176 may obtain distance data between the robot cleaner 10 and the surface to be cleaned by emitting an infrared ray toward the surface to be cleaned and then receiving the reflected infrared signal. In other words, when there is a staircase or a cliff on the moving path of the robot cleaner 10, the cliff detection sensor 176 may obtain information about a sudden change in the distance between the robot cleaner 10 and the surface to be cleaned. The cliff detection sensor 176 may be mounted on the main body 110. For example, the cliff detection sensor 176 may be disposed on the lower side 110b of the main body 110. However, the position of the cliff detection sensor 176 is not limited thereto, and any position that may obtain information about a step on the surface to be cleaned may be adopted as the position of the cliff detection sensor 176. The information obtained from the cliff detection sensor 176 may be transmitted to the processor 91.

According to various embodiments of the disclosure, at least one of the above-described plurality of sensors 171, 172, 173, 174, 175, and 176 may be omitted, or other sensors may be included in the robot cleaner 10 in addition to the above-described plurality of sensors 171, 172, 173, 174, 175, and 176.

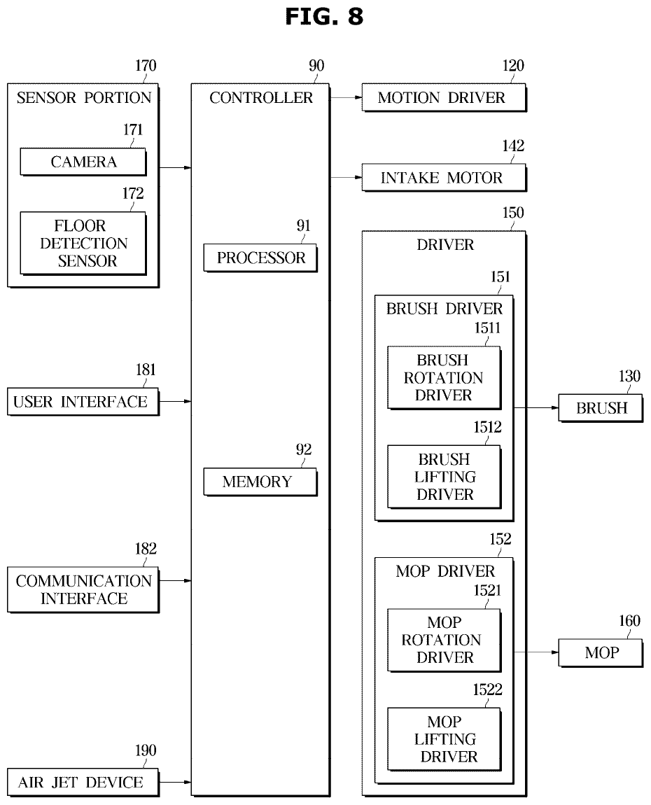

FIG. 8 is a control block diagram of a robot cleaner according to an embodiment of the disclosure.

Referring to FIG. 8, the robot cleaner 10 according to an embodiment may include the motion driver 120, the intake motor 142, a driver 150, the brush 130, the mop 160, the sensor portion 170, a user interface 181, a communication interface 182, an air jet device 190 and/or a controller 90.

The motion driver 120 may include traveling wheels 121 and 122 arranged in the main body 110, and wheel motors that provide power to the traveling wheels 121 and 122.

Rotation of the traveling wheels 121 and 122 may move the main body 110. The main body 110 may move forward, backward, or rotate by the rotation of the traveling wheel 122. For example, by rotation of both the left and right traveling wheels 121 and 122 in a forward direction, the main body 110 may move straight forward, and by rotation of both the left and right traveling wheels 121 and 122 in a backward direction, the main body 110 may move straight backward.

In addition, in a case where the left and right traveling wheels 121 and 122 rotate in the same direction but at different speeds, the main body 110 may turn to the right or left. In a case where the left and right traveling wheels 121 and 122 rotate in different directions, the main body 110 may rotate in place and turn left or right.

The wheel motor generates rotational force to rotate the traveling wheels 121 and 122. A direct current (DC) motor or a brushless DC electric motor (BLDC) may be used as the wheel motor, but the robot cleaner 10 is not limited thereto. In addition to the wheel motor, the types of other motors included in the robot cleaner 10 are not limited.

The wheel motor may include a left wheel motor that rotates the left traveling wheel and a right wheel motor that rotates the right traveling wheel.

Each of the left and right wheel motors may operate independently of each other according to a control signal from the processor 91, and the main body 110 may move forward, backward, or rotate according to the operation of the left and right wheel motors.

The processor 91 may control the movement of the robot cleaner 10 by controlling the motion driver 120. In this instance, controlling the motion driver 120 by the processor 91 may include controlling an operation of the wheel motor.

The intake motor 142 may draw in foreign substances scattered by the brush 130 into the dust bin 141, and may rotate an intake fan that generates a suction force to draw the foreign substances into the dust bin 141.

The processor 91 may control the intake motor 142 to rotate the intake fan during cleaning, thereby allowing the foreign substances scattered by the brush 130 to draw into the dust bin 141 through the inlet 111.

The driver 150 may include a brush driver 151 that drives the brush 130 and/or a mop driver 152 that drives the mop 160.

The brush driver 151 may include a brush rotation driver 1511 that rotates the brush 130 and/or a brush lifting driver 1512 that lifts or lowers the brush 130.

The brush rotation driver 1511 may include a motor. The brush rotation driver 1511 may be referred to as a motor 1511. For example, while the robot cleaner 10 is cleaning the surface to be cleaned in a dry cleaning mode or in a dry-and-wet cleaning mode, the brush rotation driver 1511 may rotate the brush 130. The processor 91 of the robot cleaner 10 may control the brush rotation driver 1511 to rotate the brush 130. Accordingly, the processor 91 may control the brush rotation driver 1511 to rotate the brush 130 during dry cleaning, thereby allowing foreign substances on the floor to be scattered by the brush 130.

The processor 91 may rotate the brush 130 by controlling the brush rotation driver 1511. The brush rotation driver 1511 may include a motor for rotating the brush 130 and a driving circuit for driving the motor.

The brush lifting driver 1512 may move the brush 130 upward or downward. The brush lifting driver 1512 may move the brush 130 upward or downward while the robot cleaner 10 is operating in a dry cleaning mode or a dry-and-wet cleaning mode.

Specifically, as the brush lifting driver 1512 moves the brush 130 upward, the brush 130 may be spaced apart from the surface to be cleaned. Based on identifying that liquid is present on the surface to be cleaned corresponding to the moving path of the robot cleaner 10, the brush lifting driver 1512 may move the brush 130 upward. Accordingly, the robot cleaner 10 may prevent the brush 130 from becoming contaminated by the liquid on the surface to be cleaned.

Conversely, as the brush lifting driver 1512 moves the brush 130 downward, the brush 130 may come into contact with the surface to be cleaned. While the robot cleaner 10 is cleaning the surface to be cleaned, the brush lifting driver 1512 may move the brush 130 downward. The processor 91 may control the brush lifting driver 1512 to move the brush 130 up and down.

The processor 91 may lift or lower the brush 130 by controlling the brush lifting driver 1512. For example, the processor 91 may move the brush 130 by controlling the brush lifting driver 1512. The brush lifting driver 1512 may include an actuator that may move the brush 130.

The mop driver 152 may include a mop rotation driver 1521 that rotates the mop 160 and/or a mop lifting driver 1522 that lifts or lowers the mop 160.

The mop rotation driver 1521 may include a motor. The mop rotation driver 1521 may be referred to as a motor 1521. For example, while the robot cleaner 10 is cleaning the surface to be cleaned in a wet cleaning mode or in a dry-and-wet cleaning mode, the mop rotation driver 1521 may rotate the mop 160. As another example, while the robot cleaner 10 is seated on the station 20 and washing and/or sterilization of the mop 160 is in progress, the mop rotation driver 1521 may rotate the mop 160. The processor 91 of the robot cleaner 10 may control the mop rotation driver 1521 to rotate the mop 160.

The processor 91 may rotate the mop 160 by controlling the mop rotation driver 1521. The mop rotation driver 1521 may include a motor for rotating the mop 160 and a driving circuit for driving the motor.

The mop lifting driver 1522 may move the mop 160 upward or downward. The mop lifting driver 1522 may move the mop 160 upward or downward while the robot cleaner 10 is operating in a wet cleaning mode or in a dry-and-wet cleaning mode.

Specifically, as the mop lifting driver 1522 moves the mop 160 upward, the mop 160 may be spaced apart from the surface to be cleaned. While the robot cleaner 10 is returning to the station 20 after completing cleaning, the mop lifting driver 1522 may move the mop 160 upward. For example, while the robot cleaner 10 is returning to the station 20 after completing intensive liquid cleaning, the lifting driver 162 may move the mop 160 upward. Accordingly, the mop 160 may be prevented from colliding with an obstacle on the surface to be cleaned or leaving moisture on the surface to be cleaned, while the robot cleaner 10 is moving to the station 20.

Conversely, as the mop lifting driver 1522 moves the mop 160 downward, the mop 160 may come into contact with the surface to be cleaned. The mop lifting driver 1522 may move the mop 160 downward, while the robot cleaner 10 is cleaning the surface to be cleaned. The processor 91 may control the mop lifting driver 1522 to move the mop 160 up and down.

The processor 91 may lift or lower the mop 160 by controlling the mop lifting driver 1522. For example, the processor 91 may move the mop 160 by controlling the mop lifting driver 1522. The mop lifting driver 1522 may include an actuator that may move the mop 160.

The sensor portion 170 may include the camera 171 and/or the floor detection sensor 172.

The camera 171 may obtain visual information about the surrounding environment of the robot cleaner 10. For example, the camera 171 may obtain visual information about the surface to be cleaned. The camera 171 may be referred to as an image sensor. The visual information obtained from the camera 171 may be transmitted to the processor 91. For example, the processor 91 may obtain consecutive images obtained at a predetermined time interval from the camera 171, while the robot cleaner 10 is moving.

The floor detection sensor 172 may obtain information for identifying whether the surface to be cleaned with which the robot cleaner 10 is in contact corresponds to a soft floor or a hard floor.

For example, the floor detection sensor 172 may be a sensor that detects a change in surface resistance. Accordingly, the floor detection sensor 172 may obtain information about a change in resistance caused by a fibrous structure, such as a carpet.

As another example, the floor detection sensor 172 may be provided as an ultrasonic sensor. Accordingly, the floor detection sensor 172 may emit an ultrasonic wave toward the surface to be cleaned, receive an echo signal reflected from the surface to be cleaned, and obtain information about a signal loss (i.e., scattering) caused by a fibrous structure, such as a carpet from the received echo signal.

The information obtained from the floor detection sensor 172 may be transmitted to the processor 91. For example, the processor 91 may compare the information obtained from the floor detection sensor 172 with a data table regarding characteristics of the floor pre-stored in the memory 92 to identify whether the surface to be cleaned corresponds to a hard floor or a soft floor.

According to various embodiments of the disclosure, the sensor portion 170 may further include various sensors in addition to the camera 171 and/or the floor detection sensor 172. For example, the sensor portion 170 may further include the obstacle detection sensor 173, the LiDAR sensor 174, and/or the wall detection sensor 175, and the cliff detection sensor 176.

The air jet device 190 may spray air onto the surface to be cleaned. The air jet device 190 may include the air discharge opening 191 and/or the third flow path 119c described above. In this instance, air whose contaminants have been filtered while passing through the dust bin 141 may move to the air discharge opening 191 through the third flow path 119c branched from the second flow path 119b, and may be sprayed onto the surface to be cleaned. The air jet device 190 may include an air jet regulating device (not shown) that regulates whether to spray air to the air discharge opening 191. The air jet regulating device may be electrically, operationally, and functionally connected to the processor 91. The processor 91 may control whether to spray air to the air discharge opening 191 by controlling the air jet regulating device. In addition, the processor 91 may regulate the pressure of the air sprayed through the air discharge opening 191 by controlling the air jet regulating device. In the disclosure, controlling the air jet device 190 by the processor 91 may include controlling the air jet regulating device of the air jet device 190.

For example, the air jet regulating device may include a valve or a damper (or an actuator that regulates the opening and closing of the damper) provided on the third flow path 119c. The processor 91 may control the valve or actuator to spray or not spray air through the air discharge opening 191. In addition, according to various embodiments of the disclosure, the pressure of the air sprayed through the air discharge opening 191 may be regulated.

According to various embodiments of the disclosure, the air jet device 190 may include an auxiliary motor provided separately from the intake motor 142, and may spray air onto the surface to be cleaned with strong air pressure by the auxiliary motor.

According to various embodiments of the disclosure, the air jet device 190 may further include other components in addition to the above-described components, or some of the above-described components of the air jet device 190 may be omitted. The air jet device is not limited to the description above, and any device that may spray contaminant-free air onto the surface to be cleaned at a predetermined pressure or higher may be adopted as the air jet device 190.

The user interface 181 may include an output interface and an input interface.

At least one output interface may generate sensory information and transmit various information related to operations of the robot cleaner 10 to a user.

For example, the at least one output interface may transmit information related to the settings and the operating time of the robot cleaner 10 to the user. Information about the operation of the robot cleaner 10 may be output as a display, an indicator, and/or a voice. The at least one output interface may include, for example, a liquid crystal display (LCD) panel, an indicator, a light emitting diode (LED) panel, a speaker, and the like.

In a case where the display includes a touch screen display, the touch screen display may correspond to an example of an output interface and an input interface.

In an embodiment of the disclosure, the at least one output interface may output sensory information (e.g., visual information, auditory information, or the like) related to the control of the robot cleaner 10.

At least one input interface may convert sensory information received from the user into an electrical signal.

The at least one input interface may include a power button for turning on the robot cleaner 10.

Each button may include a visual indicator (e.g., text, icon, or the like) that may indicate its function.

The at least one input interface may include, for example, a tact switch, a push switch, a slide switch, a toggle switch, a micro switch, a touch switch, a touch pad, a touch screen, a jog dial, and/or a microphone, and the like.

In the disclosure, a “button” may be replaced by a user interface (UI) element, a tact switch, a push switch, a slide switch, a toggle switch, a micro switch, a touch switch, a touch pad, a touch screen, a jog dial, and/or a microphone, and the like.

The robot cleaner 10 may process a user input received via the user interface 181 and may output information related to the robot cleaner 10 via the user interface 181.

In an embodiment of the disclosure, the user interface 181 may include an input interface for receiving a user command about a cleaning mode. In this instance, the cleaning mode may include at least one of at least one of a dry cleaning mode, a wet cleaning mode, or a dry-and-wet cleaning mode.

When a user command about a cleaning mode is input via the input interface, the processor 91 may control the robot cleaner 10 in response to the cleaning mode. In addition, when a user command about a cleaning mode is input via the input interface, the processor 91 may transmit a control command signal according to each cleaning mode to the station 20.

The communication interface 182 may communicate with an external device (e.g., a server, a user device, the station 20) by wire and/or wirelessly.

The communication interface 182 may transmit data to an external device (e.g., a server, a user device, the station 20) or receive data from the external device. To this end, the communication interface 182 may support the establishment of a direct (e.g., wired) communication channel or a wireless communication channel between external devices, and the performance of communication through the established communication channel. According to an embodiment of the disclosure, the communication interface 182 may include a wireless communication module (e.g., a cellular communication module, a short-range wireless communication module, or a global navigation satellite system (GNSS) communication module) or a wired communication module (e.g., a local area network (LAN) communication module, or a power line communication module). The corresponding communication module among these communication modules may communicate with an external device through a first network (e.g., a short-range wireless communication network, such as Bluetooth, wireless fidelity (Wi-Fi) direct, or infrared data association (IrDA)) or a second network (e.g., a long-range wireless communication network, such as a legacy cellular network, a fifth generation (5G) network, a next-generation communication network, the Internet, or a computer network (e.g., LAN or WAN)). These various types of communication modules may be integrated into one component (e.g., a single chip) or may be implemented as a plurality of separate components (e.g., a plurality of chips).

The short-range wireless communication module may include a Bluetooth communication module, a Bluetooth low energy (BLE) communication module, a near field communication module, a wide LAN (WLAN) (Wi-Fi) communication module, a Zigbee communication module, an infrared data association (IrDA) communication module, a Wi-Fi direct (WFD) communication module, an ultrawideband (UWB) communication module, an Ant+ communication module, a microwave (uWave) communication module, and the like, but is not limited thereto.

The long-range wireless communication module may include a communication module that performs various types of long-range wireless communication, and may include a mobile communication interface. The mobile communication interface transmits and receives radio signals with at least one of a base station, an external terminal, and a server on a mobile communication network.

In an embodiment of the disclosure, the communication interface 182 may communicate with an external device through a nearby access point (AP). The AP may connect a local area network (LAN) to which the robot cleaner 10 is connected to a wide area network (WAN) to which a server is connected. The robot cleaner 10 may be connected to the server through the wide area network (WAN).

In an embodiment of the disclosure, the communication interface 182 may communicate wirelessly with the station 20.

The controller 90 may control the overall operation of the robot cleaner 10.

The controller 90 may include at least one processor 91 that controls an operation of the robot cleaner 10 and at least one memory 92 that stores a program and data for controlling the operation of the robot cleaner 10. In this instance, the controller 90 may be referred to as the robot cleaner controller 90, the processor 91 may be referred to as the robot cleaner processor 91, and the memory 92 may be referred to as the robot cleaner memory 92.

The at least one processor 91 may control the overall operation of the robot cleaner 10. Specifically, the at least one processor 91 may be connected to each component of the robot cleaner 10 to control the overall operation of the robot cleaner 10. For example, the at least one processor 91 may be electrically connected to the memory 92 to control the overall operation of the robot cleaner 10. A single or a plurality of processors 91 may be provided.

The at least one processor 91 may perform the operation of the robot cleaner 10 according to various embodiments by executing at least one instruction stored in the memory 92.

The at least one memory 92 may store data required for various embodiments. The memory 92 may be implemented as memory embedded in the robot cleaner 10 or as memory detachable from the robot cleaner 10 depending on the data storage use. For example, data for driving the robot cleaner 10 may be stored in the memory embedded in the robot cleaner 10, and data for an extended function of the robot cleaner 10 may be stored in the memory detachable from the robot cleaner 10. Meanwhile, the memory embedded in the robot cleaner 10 may be implemented as at least one of a volatile memory (e.g., dynamic random access memory (DRAM), static RAM (SRAM), or synchronous dynamic RAM (SDRAM), or the like), or a non-volatile memory (e.g., one time programmable read only memory (OTPROM), programmable ROM (PROM), erasable programmable ROM (EPROM), electrically erasable programmable ROM (EEPROM), mask ROM, flash ROM, flash memory (e.g., NAND flash or NOR flash, or the like), a hard drive, or a solid state drive (SSD)). In addition, the memory detachable from the robot cleaner 10 may be implemented as a memory card (e.g., compact flash (CF), secure digital (SD), micro secure digital (Micro-SD), mini secure digital (Mini-SD), extreme digital (xD), multi-media card (MMC), or the like), external memory (e.g., universal serial bus (USB) memory) connectable to a USB port, and the like.

The at least one processor 91 may include at least one of a central processing unit (CPU), graphics processing unit (GPU), accelerated processing unit (APU), many integrated core (MIC), digital signal processor (DSP), neural processing unit (NPU), hardware accelerator, or machine learning accelerator. The at least one processor 91 may control one or any combination of other components of the robot cleaner 10, and may perform communication-related operations or data processing. The at least one processor 91 may execute at least one program or instruction stored in the memory 92. For example, the at least one processor 91 may execute at least one instruction stored in the memory 92 to perform a method according to at least one embodiment of the disclosure.

In an embodiment of the disclosure, the processor 91 may control the driver 150 according to a predetermined condition. Controlling the driver 150 may include rotating the brush 130 or the mop 160, or moving the brush 130 or the mop 160 upward or downward.

In an embodiment of the disclosure, the processor 91 may control the motion driver 120 according to a predetermined condition. Controlling the motion driver 120 may include decreasing or increasing a traveling speed of the robot cleaner 10.

In an embodiment of the disclosure, the processor 91 may determine whether to spray air onto the surface to be cleaned through the air jet device 190 based on an image of the surface to be cleaned obtained from the camera 171. For example, the processor 91 may identify whether the image obtained from the camera 171 includes a preset shape. In this instance, information about the preset shape may be stored in the memory 92. The processor 91 may determine to spray air through the air jet device 190 based on the image obtained from the camera 171 including the preset shape.

The processor 91 may control the camera 171 to obtain consecutive images of the surface to be cleaned while air is being sprayed from the air jet device 190 to the surface to be cleaned. The processor 91 may identify a target object as liquid based on a shape change of the target object included in the consecutive images obtained from the camera 171.

In addition, the processor 91 may control the camera 171 to obtain images of the surface to be cleaned before the air jet device 190 sprays air onto the surface to be cleaned and after spraying air onto the surface to be cleaned is completed, respectively. The processor 91 may identify the target object as liquid based on a shape change of the target object included in the images obtained from the camera 171.

The processor 91 may control the motion driver 120 to decrease a traveling speed of the robot cleaner 10 based on identifying the target object as liquid.

The processor 91 may control the driver 150 to allow the robot cleaner 10 to perform a preset operation corresponding to the cleaning mode being currently performed by the robot cleaner 10.

The processor 91 may control the brush lifting driver 1512 to lift the brush 130 before the robot cleaner 10 reaches the liquid, based on the robot cleaner 10 operating in a dry cleaning mode.

The processor 91 may control the motion driver 120 to perform liquid avoidance driving to prevent the robot cleaner 10 from reaching the liquid, based on the robot cleaner 10 operating in the dry cleaning mode.

The processor 91 may control at least one of the motion driver 120 or the mop rotation driver 1521 to allow the robot cleaner 10 to perform intensive cleaning with respect to the identified liquid (hereinafter referred to as “intensive liquid cleaning”), based on the robot cleaner 10 operating in the wet cleaning mode.

To perform intensive liquid cleaning, the processor 91 may control the motion driver 120 to move the robot cleaner to a position at which the liquid is identified as existing, and to allow the robot cleaner 10 to perform a spiral drive or a forward-and-backward repetitive drive at the position at which the liquid is identified as existing.

The processor 91 may control the mop rotation driver 1521 to increase or decrease a rotation speed of the mop, based on the robot cleaner 10 being moved to the position at which the liquid is identified as existing to perform intensive liquid cleaning.

The processor 91 may control the motion driver 120 to return the robot cleaner 10 to the station 20 after performing the intensive liquid cleaning.

Based on the robot cleaner 10 operating in the dry-and-wet cleaning mode, the processor 91 may control the brush lifting driver 1512 to lift the brush 130 before the robot cleaner 10 reaches the liquid, and based on the brush 130 being lifted, may control at least one of the motion driver 120 or the mop rotation driver 1521 to allow the robot cleaner 10 to perform intensive liquid cleaning. In addition, the processor 91 may control the motion driver 120 to return the robot cleaner 10 to the station 20 after performing the intensive liquid cleaning.

The processor 91 may identify whether a washing process of the mop 160 is completed after the robot cleaner 10 returns to the station 20, and may control the motion driver 120 to move the robot cleaner 10 to a position at which the liquid is identified as existing or a cleaning area closest to the station 20 based on the washing process of the mop 160 being completed. In this instance, the cleaning area may be a divided area included in a cleaning map, and may correspond to a range in which a single cleaning cycle is completed.

The processor 91 may identify whether the surface to be cleaned with which the robot cleaner 10 is in contact corresponds to a soft floor based on information obtained from the floor detection sensor 172, and may control the motion driver 120 to perform liquid avoidance driving to prevent the robot cleaner 10 from reaching the liquid based on identifying that the surface to be cleaned corresponds to a soft floor.

The above-described operations for controlling the robot cleaner 10 by the processor 91 may be performed by a processor (not shown) included in the station. For example, the processor of the station 20 may transmit a control signal to the robot cleaner to control the operation of the robot cleaner 10.

In addition, the robot cleaner 10 may include a battery.

The battery may supply power to various electronic components of the robot cleaner 10. The battery may be charged while the robot cleaner 10 is seated on the station 20.

The robot cleaner 10 may include a battery sensor for detecting a charge level of the battery.

The controller 90 may control the motion driver 120 to return the robot cleaner 10 to the station 20 when the charge level of the battery falls below a predetermined level.

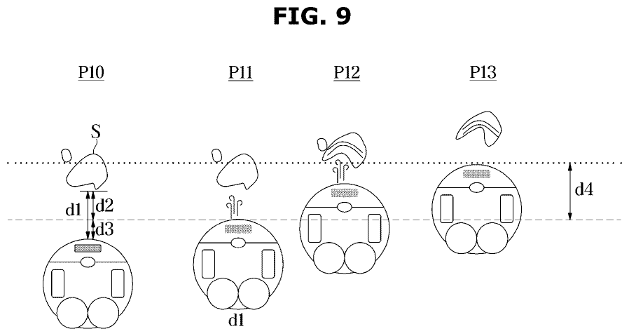

FIG. 9 illustrates a robot cleaner moving forward and spraying air forward through an air jet device over time according to an embodiment of the disclosure.

Referring to FIG. 9, the robot cleaner 10 may obtain an image of a surface to be cleaned through the camera 171.

Specifically, the robot cleaner 10 may obtain an image of the forward surface to be cleaned (hereinafter also referred to as “forward cleaning surface”) of the robot cleaner 10 through the camera 171 while continuing to travel (P10). In this instance, the forward cleaning surface of the robot cleaner 10 may include an area located in the traveling direction of the robot cleaner 10 based on the robot cleaner 10. In other words, the forward cleaning surface may include an area that the robot cleaner 10 will clean in the future. For example, the robot cleaner 10 may obtain an image of the forward cleaning surface that is a predetermined distance away from the robot cleaner 10.

The robot cleaner 10 may determine whether the obtained image of the forward cleaning surface includes a shape of a target object S. In this instance, the target object S may refer to an object on the surface to be cleaned, which may later be identified as liquid. For example, the processor 91 may preprocess the image, extract features from the image, and identify whether the shape of the target object is included in the image based on the extracted features. In this instance, various methods may be used to preprocess the image or extract features from the preprocessed image. For example, the processor 91 may remove noise from the obtained image and adjust a contrast to emphasize the features of the obtained image. The processor 91 may also use an edge detection or Hough transform method to extract features from the preprocessed image. In this instance, the processor 91 may use a machine learning model to perform a series of processes of identifying whether the image of the forward cleaning surface includes the shape of the target object. The processor 91 may use a machine learning model stored in the memory 92, or stored in an external device (e.g., server 3).

Based on identifying that the obtained image includes the shape of the target object S, the robot cleaner 10 may obtain position data of the target object (e.g., the target object is located in the kitchen) and/or distance data between the robot cleaner 10 and the shape of the target object (e.g., d1 in FIG. 9) from at least one sensor included in the sensor portion 170.

In addition, based on identifying that the obtained image includes the shape of the target object, the robot cleaner 10 may spray air toward the target object S while moving toward the target object S.

The robot cleaner 10 may determine a time to start spraying air toward the target object under a preset condition. For example, the processor 91 may control the air jet device 190 to start spraying air from the time when a distance between the robot cleaner 10 and the shape of the target object S reaches a preset distance (e.g., d2 in FIG. 9) while the robot cleaner 10 continues to travel (P11). In other words, the processor 91 may move the robot cleaner 10 by a predetermined distance (e.g., d3 in FIG. 9) until the distance between the robot cleaner 10 and the shape of the target object S reaches the preset distance (e.g., d2 in FIG. 9), and then control the air jet device 190 to start spraying air.

In this instance, the preset distance between the robot cleaner 10 and the shape of the target object S may include a calculated distance that the liquid will travel due to the air spray pressure. The preset distance may be adjusted according to the air spray pressure.

The robot cleaner 10 may continue to spray air toward the target object S while traveling a preset distance (e.g., d4 in FIG. 9) from the time when the air spray toward the target object S is started (P12). In this instance, the distance traveled by the robot cleaner 10 while spraying air may be determined so that the robot cleaner 10 does not come into contact with the target object S. In this instance, the processor 91 may control the motion driver 120 to adjust a traveling speed of the robot cleaner 10 from the start to completion of the air spray, considering the movement distance and speed of the target object S due to the sprayed air.

The robot cleaner 10 may stop spraying air toward the target object S, based on the robot cleaner having moved the preset distance (e.g., d4 in FIG. 9) from the time when the air spray toward the target object S was started (P13).

The robot cleaner 10 may obtain a plurality of images of the surface to be cleaned based on the air being sprayed toward the target object S. In this instance, the plurality of images of the surface to be cleaned may include a plurality of images of the forward cleaning surface of the robot cleaner 10.

For example, the robot cleaner 10 may obtain a plurality of images of the surface to be cleaned before the air spray toward the target object S is started and after the air spray toward the target object S is completed.

In this instance, obtaining the plurality of images of the surface to be cleaned may include obtaining consecutive images of the surface to be cleaned. In this instance, the consecutive images may correspond to a plurality of images obtained for the same object at a preset unit time interval. The consecutive images of the surface to be cleaned may include consecutive images of the forward cleaning surface of the robot cleaner 10.

For example, the robot cleaner 10 may obtain consecutive images of the surface to be cleaned while air is being sprayed toward the target object S.

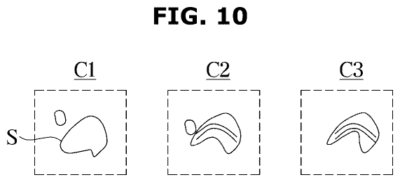

The robot cleaner 10 may determine whether the target object S is liquid based on the obtained plurality of images (i.e., consecutive images), which will be described below with reference to FIG. 10.

FIG. 10 illustrates consecutive images obtained while a robot cleaner of FIG. 9 sprays air forward according to an embodiment of the disclosure.

Referring to FIG. 10, C1, C2, and C3, correspond to consecutive images obtained at positions P11, P12, and P13 of FIG. 9, respectively. For example, C1, C2, and C3 of FIG. 10 each show the shape of the target object S changed while air is sprayed by the air jet device 190 of the robot cleaner 10.

According to an embodiment of the disclosure, the processor 91 may identify the target object S as liquid based on the shape change of the target object S included in the consecutive images obtained by the camera 171.

When force is applied to liquid, the contour of the liquid may change due to the hydrodynamic properties of the liquid. The contour of liquid may be referred to as an outline or a boundary line of the liquid.

In a case where the target object S is liquid, when air is sprayed toward the target object S by the robot cleaner 10, pressure is applied to the target object S by the sprayed air and the contour of the target object S may change. The contour of the target object may be referred to as an outline or a boundary line of the target object.

Accordingly, the processor 91 may identify the target object S as liquid based on the contour change of the target object S included in the consecutive images. In other words, the processor 91 may identify that liquid is present on the surface to be cleaned, based on the contour change of the target object S included in the consecutive images.

When force is applied to liquid, a state of liquid surface may change due to the surface tension of the liquid. For example, when the force applied to the liquid surface is greater than the surface tension, ripples may form on the liquid surface, or waves may occur.

In a case where the target object S is liquid, when air is sprayed toward the target object S by the robot cleaner 10, pressure is applied to the target object S by the sprayed air, and the surface state of the target object S may change. For example, in a case where the target object S is liquid, when air is sprayed toward the target object S by the robot cleaner 10, pressure is applied to the target object S by the sprayed air, and thus a ripple pattern may be formed on the surface of the target object S.

Accordingly, the processor 91 may identify the target object S as liquid based on the surface state change of the target object S included in the consecutive images. In other words, the processor 91 may identify that liquid is present on the surface to be cleaned based on the surface state change of the target object S included in the consecutive images.

According to various embodiments of the disclosure, the processor 91 may use various methods to identify whether the shape of the target object changes. For example, the processor 91 may recognize an area where the pixel value changes rapidly in an image as a contour, and identify the change in the shape of the target object by comparing the contours between consecutive images.

According to an embodiment of the disclosure, the processor 91 may control the motion driver 120 to decrease a traveling speed of the robot cleaner 10 based on identifying the target object S as liquid.

In addition, the processor 91 may control the driver 150 to allow the robot cleaner 10 to perform a preset operation corresponding to a cleaning mode being currently performed by the robot cleaner 10, based on identifying the target object S as liquid. In this instance, the cleaning mode of the robot cleaner 10 may include at least one of a dry cleaning mode, a wet cleaning mode, or a dry-and-wet cleaning mode.

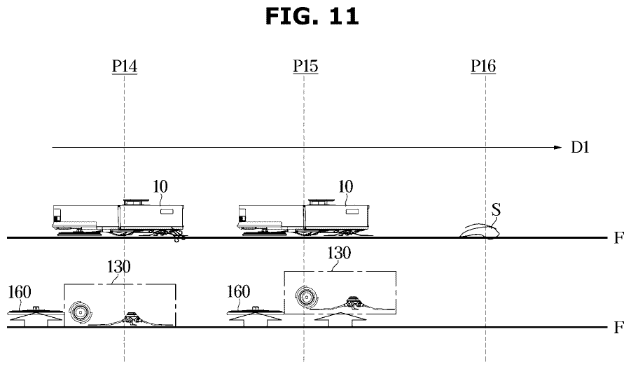

Hereinafter, the preset operations corresponding to the current cleaning mode performed by the robot cleaner 10 based on identifying the target object S as liquid are described with reference to FIG. 11 to FIG. 14.

FIG. 11 illustrates a preset operation of a robot cleaner when liquid is detected during a dry cleaning mode according to an embodiment of the disclosure.

Referring to FIG. 11, a case where the robot cleaner 10 is traveling on a surface to be cleaned (e.g., F in FIG. 11) in a D1 direction is described as an example.

P14 shows the position of the robot cleaner 10 and the positions of the brush 130 and the mop 160 in a state where the robot cleaner 10 has not detected the presence of liquid on the forward cleaning surface.

P15 shows the position of the robot cleaner 10 and the positions of the brush 130 and the mop 160 before reaching the position at which liquid exists, after the robot cleaner 10 has detected the presence of liquid on the forward cleaning surface.

P16 shows the position at which liquid exists.

According to an embodiment of the disclosure, the robot cleaner 10 may operate in a dry cleaning mode when a user input about a cleaning mode is received, or under a preset condition. In the dry cleaning mode, the robot cleaner 10 may pick up (intake) dirt on the surface to be cleaned using the suction force by the intake motor 142 without using water.

As shown in P14, in the dry cleaning mode, the brush 130 may be in contact with the surface to be cleaned to scatter dirt by scrubbing the surface to be cleaned. In addition, in the dry cleaning mode, the mop 160 may be detached or lifted so as not to contact the surface to be cleaned. For example, while the robot cleaner 10 is in the dry cleaning mode, the processor 91 may control the brush lifting driver 1512 to allow the brush 130 to contact the surface to be cleaned.

In this instance, in a case where the processor 91 identifies that liquid exists on the surface to be cleaned, based on the robot cleaner 10 being in the dry cleaning mode, the processor 91 may control the brush lifting driver 1512 to lift the brush 130, as shown in P15, before the robot cleaner 10 reaches the liquid. For example, the brush 130 may be spaced apart from the surface to be cleaned. As a result, the robot cleaner 10 may prevent the brush 130 from being contaminated by the liquid.

Afterwards, based on the robot cleaner 10 operating in the dry cleaning mode, the processor 91 may control the motion driver 120 to allow the robot cleaner 10 to perform liquid avoidance driving to prevent the robot cleaner 10 from reaching the liquid. In this instance, the liquid avoidance driving may include changing the existing traveling path (e.g., D1) and traveling in a direction in which the robot cleaner 10 does not contact or pass through the liquid. Accordingly, as shown in P16, the robot cleaner 10 will not be located at the position at which the liquid is identified as existing.

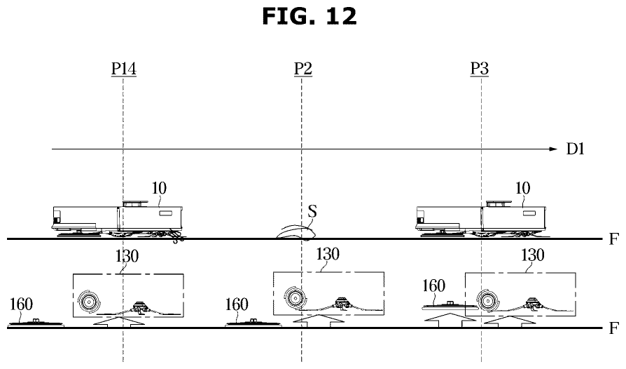

FIG. 12 illustrates a preset operation of a robot cleaner when liquid is detected during a wet cleaning mode according to an embodiment of the disclosure.

Referring to FIG. 12, a case where the robot cleaner 10 is traveling on a surface to be cleaned (e.g., F in FIG. 12) in a D1 direction is described as an example.

P14 shows the position of the robot cleaner 10 and the positions of the brush 130 and the mop 160 in a state where the robot cleaner 10 has not detected the presence of liquid on the forward cleaning surface.

P2 shows the position of the robot cleaner 10 and the positions of the brush 130 and the mop 160 when the robot cleaner 10 has reached the position at which liquid exists, after detecting the presence of liquid on the forward cleaning surface.

P3 shows the position of the robot cleaner 10 and the positions of the brush 130 and the mop 160 after the robot cleaner 10 has passed the position at which liquid exists.

According to an embodiment of the disclosure, the robot cleaner 10 may operate in a wet cleaning mode when a user input about a cleaning mode is received, or under a preset condition. In the wet cleaning mode, the robot cleaner 10 may remove dirt on the surface to be cleaned by wiping the surface to be cleaned with the mop 160 using water, or by spraying water onto the surface to be cleaned.

In the wet cleaning mode, the brush 130 may be spaced apart from the surface to be cleaned to prevent contamination from liquid-like dirt or contaminated water, after removing the dirt. On the other hand, in the wet cleaning mode, the mop 160 may be in contact with the surface to be cleaned.

For example, as shown in P14, in the wet cleaning mode, the processor 91 may control the brush lifting driver 1512 to lift the brush 130 to prevent the brush 130 from contacting the surface to be cleaned. In addition, in the wet cleaning mode, the processor 91 may control the mop lifting driver 1522 to bring the mop 160 into contact with the surface to be cleaned.

In this instance, in a case where the processor 91 identifies that liquid exists on the surface to be cleaned, based on the robot cleaner 10 being in the wet cleaning mode, the processor 91 may control at least one of the motion driver 120 or the mop rotation driver 1521 to allow the robot cleaner 10 to perform intensive liquid cleaning when the robot cleaner 10 reaches the liquid. As a result, as shown in P2, when the robot cleaner 10 reaches the liquid, the brush 130 may be spaced apart from the surface to be cleaned, and the mop 160 may be in contact with the surface to be cleaned.

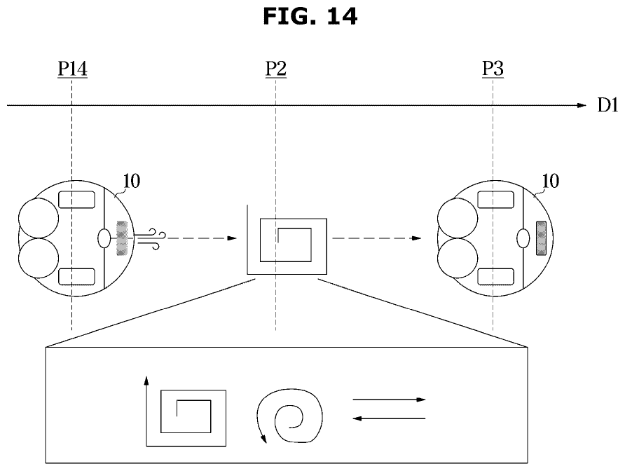

In this instance, a method for performing intensive liquid cleaning will be described with reference to FIG. 14.

Afterwards, as shown in P3, the processor 91 may control the mop lifting driver 1522 to lift the mop 160 to prevent the mop 160 from contacting the surface to be cleaned after completing the intensive liquid cleaning. Accordingly, the surface to be cleaned may be prevented from being contaminated by the contaminated (used) mop 160 or the contaminated water contained in the mop 160.

Afterwards, the processor 91 may control the motion driver 120 to return the robot cleaner 10 to the station 20 after completing the intensive liquid cleaning.

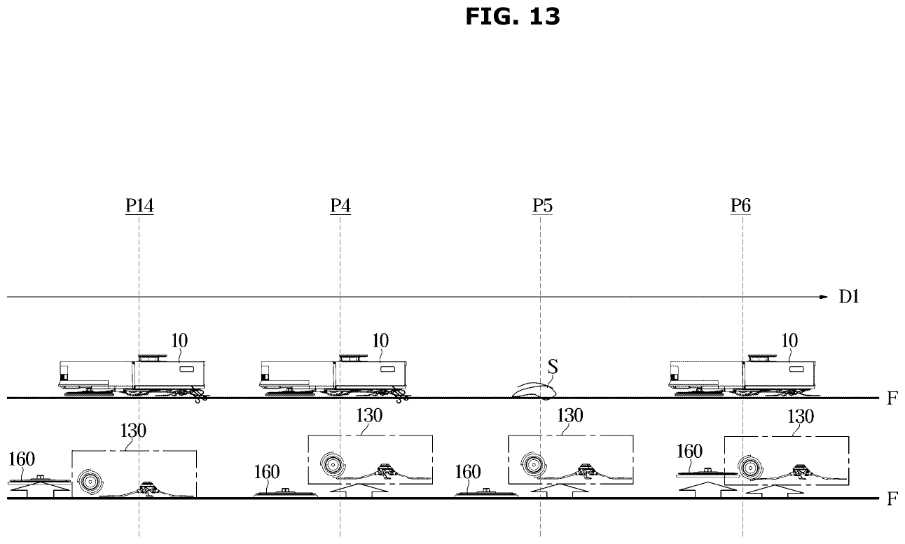

FIG. 13 illustrates a preset operation of a robot cleaner when liquid is detected during a dry-and-wet cleaning mode according to an embodiment of the disclosure.

Referring to FIG. 13, a case where the robot cleaner 10 is traveling on a surface to be cleaned (e.g., F in FIG. 13) in a D1 direction is described as an example.

P14 shows the position of the robot cleaner 10 and the positions of the brush 130 and the mop 160 in a state where the robot cleaner 10 has not detected the presence of liquid on the forward cleaning surface.

P4 shows the position of the robot cleaner 10 and the positions of the brush 130 and the mop 160 before reaching the position at which liquid exists, after the robot cleaner 10 has detected the presence of liquid on the forward cleaning surface.

P5 shows the position of the robot cleaner 10 and the positions of the brush 130 and the mop 160 when the robot cleaner 10 has reached the position at which liquid exists, after detecting the presence of liquid on the forward cleaning surface.

P6 shows the position of the robot cleaner 10 and the positions of the brush 130 and the mop 160 after the robot cleaner 10 has passed the position at which liquid exists.

According to an embodiment of the disclosure, the robot cleaner 10 may operate in a dry-and-wet cleaning mode when a user input about a cleaning mode is received, or under a preset condition. In the dry-and-wet cleaning mode, the robot cleaner 10 may remove dirt on the surface to be cleaned by wiping the surface to be cleaned with the mop 160 using water, or by spraying water onto the surface to be cleaned. In addition, the robot cleaner 10 may pick up (intake) dirt on the surface to be cleaned using the suction force by the intake motor 142 without using water. For example, in the dry-and-wet cleaning mode, the robot cleaner 10 may simultaneously perform the operations in the dry cleaning mode and the operations in the wet cleaning mode. In this instance, the robot cleaner 10 may perform the operations in the dry cleaning mode and the operations in the wet cleaning mode simultaneously or at different times.

In the dry-and-wet cleaning mode, the brush 130 may be in contact with the surface to be cleaned. In addition, in the dry-and-wet cleaning mode, the mop 160 may also be in contact with the surface to be cleaned.

For example, as shown in P14, in the dry-and-wet cleaning mode, the processor 91 may control the brush lifting driver 1512 to bring the brush 130 into contact with the surface to be cleaned. In addition, in the dry-and-wet cleaning mode, the processor 91 may control the mop lifting driver 1522 to bring the mop 160 into contact with the surface to be cleaned.

In this instance, as shown in P4, in a case where the processor 91 identifies that liquid exists on the surface to be cleaned, based on the robot cleaner 10 being in the dry-and-wet cleaning mode, the processor 91 may control the brush lifting driver 1512 to lift the brush 130 before the robot cleaner 10 reaches the liquid. For example, the brush 130 may be spaced apart from the surface to be cleaned. Accordingly, the robot cleaner 10 may prevent the brush 130 from being contaminated by the liquid.

In addition, in a case where the processor 91 identifies that liquid exists on the surface to be cleaned, based on the robot cleaner 10 being in the dry-and-wet cleaning mode, the processor 91 may control at least one of the motion driver 120 or the mop rotation driver 1521 to allow the robot cleaner 10 to perform intensive liquid cleaning when the robot cleaner 10 reaches the liquid. Accordingly, as shown in P5, when the robot cleaner 10 reaches the liquid, the brush 130 may be spaced apart from the surface to be cleaned, and the mop 160 may be in contact with the surface to be cleaned.

In this instance, a method for performing intensive liquid cleaning will be described with reference to FIG. 14.

Afterwards, as shown in P6, the processor 91 may control the mop lifting driver 1522 to lift the mop 160 to prevent the mop 160 from contacting the surface to be cleaned after completing the intensive liquid cleaning. Accordingly, the surface to be cleaned may be prevented from being contaminated by the used mop 160 or the contaminated water contained in the mop 160.

Afterwards, the processor 91 may control the motion driver 120 to return the robot cleaner 10 to the station 20 after completing the intensive liquid cleaning.

FIG. 14 illustrates that a robot cleaner performs intensive liquid cleaning according to an embodiment of the disclosure.

Referring to FIG. 14, according to an embodiment of the disclosure, the robot cleaner 10 may perform intensive liquid cleaning to remove liquid, based on identifying that liquid exists on a surface to be cleaned while the robot cleaner 10 is operating in a wet cleaning mode or a dry-and-wet cleaning mode. Hereinafter, although a series of positions P14, P2, and P3 of the robot cleaner 10 during the wet cleaning mode will be described as an example, the same operations of the intensive liquid cleaning may be performed in the dry-and-wet cleaning mode.

According to an embodiment of the disclosure, based on identifying that liquid exists on the surface to be cleaned, the processor 91 may control at least one of the motion driver 120 or the mop rotation driver 1521 to allow the robot cleaner 10 to perform intensive liquid cleaning when the robot cleaner 10 reaches the liquid.

For example, the processor 91 may control the motion driver 120 to move the robot cleaner 10 to the position at which the liquid exists to perform intensive liquid cleaning. For example, the processor 91 may move the robot cleaner 10 from P14 to P2.

Afterwards, as shown in FIG. 14, the processor 91 may control the motion driver 120 to allow the robot cleaner 10 to perform a spiral drive or a forward-and-backward repetitive drive at the position at which the liquid is identified as existing. Accordingly, the robot cleaner 10 may repeatedly pass through the position at which the liquid exists, thereby increasing the contact frequency between the liquid and the mop 160 and improving the liquid removal efficiency.

In this instance, the driving method of the robot cleaner 10 at the position at which the liquid exists is not limited to the spiral drive or the forward-and-backward repetitive drive, and any method that may increase the contact frequency between the liquid and the mop 160 may be adopted as the driving method of the robot cleaner 10.

As another example, the processor 91 may control the mop rotation driver 1521 to increase or decrease a rotation speed of the mop 160, based on moving the robot cleaner 10 to the position at which the liquid exists to perform intensive liquid cleaning.

As the rotation speed of the mop 160 increases, the contact frequency between the liquid and the mop 160 may be increased, thereby improving the liquid removal efficiency. In addition, as the frictional force between the mop 160 and the surface to be cleaned increases, viscous liquid may also be wiped off, and thus the liquid removal efficiency may be improved.

As the rotation speed of the mop 160 decreases, the mop 160 may sufficiently absorb the liquid, thereby improving the liquid removal efficiency.

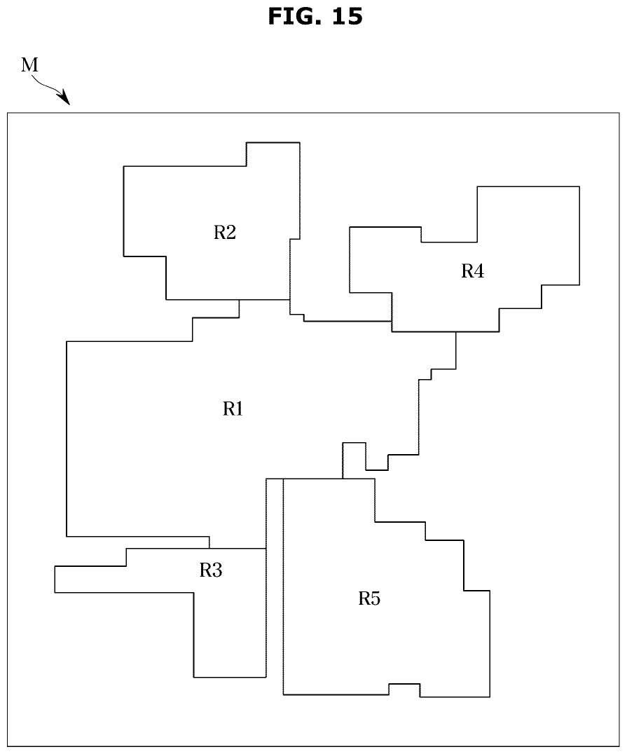

FIG. 15 illustrates a cleaning map and a cleaning area according to an embodiment of the disclosure.

Referring to FIG. 15, according to an embodiment of the disclosure, the memory 92 may store a map of an area to be cleaned by the robot cleaner 10 (hereinafter, referred to as a “cleaning map M”). The cleaning map M may include information about at least one cleaning area R1, R2, R3, R4, and R5, which is a divided area included in the cleaning map and is a range in which a single cleaning cycle is completed. The memory 92 may store characteristics of each cleaning area R1, R2, R3, R4, and R5, a preset cleaning mode and traveling speed of the robot cleaner 10 for each cleaning area R1, R2, R3, R4, and R5, and/or a liquid detection history of each cleaning area R1, R2, R3, R4, and R5. In this instance, the characteristics of each cleaning area R1, R2, R3, R4, and R5 may include information about a user's living space (kitchen, room, bathroom, living room, or the like) corresponding to each cleaning area.

In addition, the cleaning map M may further include information about the positions of walls and doors in the area to be cleaned, information about the positions of fixed structures (e.g., furniture), and information about characteristics of the surface to be cleaned (e.g., carpet, marble, wood, or the like) in the area to be cleaned.

The processor 91 may generate or update the cleaning map M based on information obtained from the sensor portion 170. For example, the processor 91 may obtain information about the positions of walls, doors, or the like, by analyzing an image obtained from the camera 171, and convert the obtained information into the cleaning map M. According to various embodiments of the disclosure, the processor 91 may control the communication interface 182 to receive information about the cleaning map M from an external device (e.g., server 3 of FIG. 1). The processor 91 may generate or update the cleaning map M based on the information about the cleaning map M received from the external device through the communication interface 182. According to various embodiments of the disclosure, the processor 91 may also generate or update the cleaning map M based on a user input received via the user interface 181.

The processor 91 according to an embodiment may determine a traveling path of the robot cleaner 10 based on the information included in the cleaning map M. The processor 91 may control the motion driver 120 to allow the robot cleaner 10 to travel based on the determined traveling path. In addition, the processor 91 may control the user interface 181 to display the determined traveling path together with the cleaning map M and/or information included in the cleaning map M.

The processor 91 according to an embodiment may determine a traveling speed of the robot cleaner 10 based on the information included in the cleaning map M. The processor 91 may control the motion driver 120 to move the robot cleaner 10 based on the determined traveling speed. In addition, the processor 91 may control the user interface 181 to display the determined traveling speed together with the cleaning map M and/or information included in the cleaning map M.

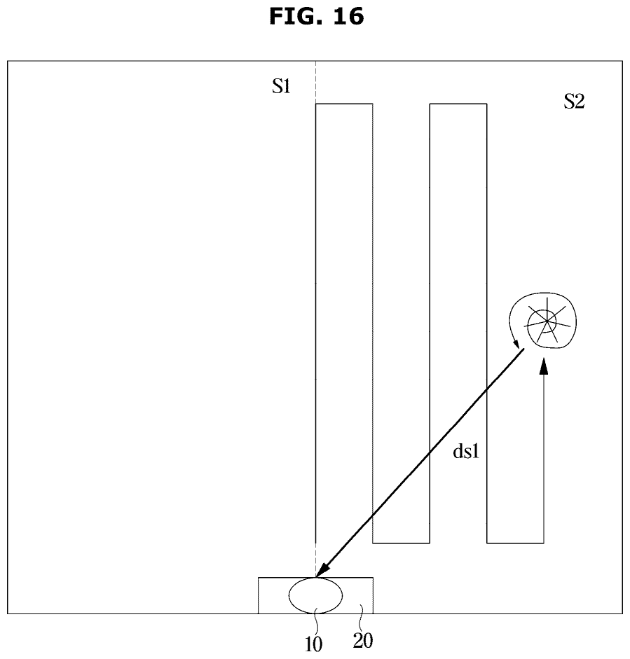

FIG. 16 illustrates a path for a robot cleaner to return to a station after performing intensive liquid cleaning according to an embodiment of the disclosure.

Referring to FIG. 16, according to an embodiment of the disclosure, the processor 91 may control the motion driver 120 to return the robot cleaner 10 to the station 20 after performing intensive liquid cleaning in a wet cleaning mode or a dry-and-wet cleaning mode.

In this instance, the processor 91 may control the mop lifting driver 1522 to raise the mop 160 away from the surface to be cleaned while the robot cleaner 10 is returning to the station 20. Accordingly, the robot cleaner 10 may prevent the surface to be cleaned from being contaminated by the used mop 160 after performing the intensive liquid cleaning.

The processor 91 may determine the shortest distance (e.g., ds1 in FIG. 16) between the current position of the robot cleaner 10 (i.e., the position at which liquid is detected) and the position of the station 20 based on the information included in the cleaning map M stored in the memory 92. Accordingly, the processor 91 may control the motion driver 120 to move the robot cleaner 10 along the shortest path while returning to the station 20.

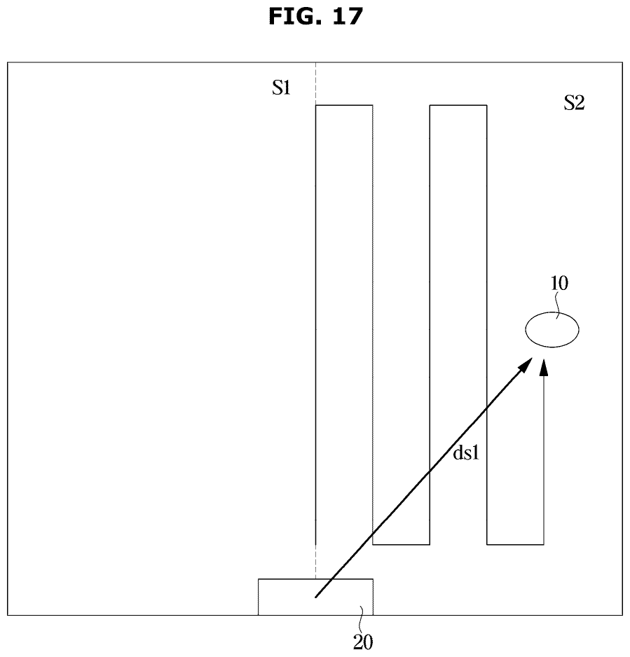

FIG. 17 illustrates a path for a robot cleaner to move to resume cleaning after returning to a station and performing mop washing according to an embodiment of the disclosure.

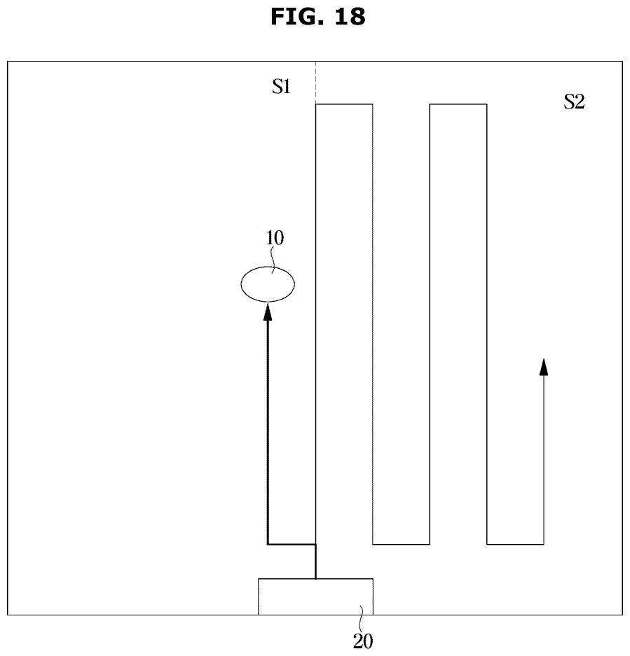

FIG. 18 illustrates a path for a robot cleaner to move to resume cleaning after returning to a station and performing mop washing according to an embodiment of the disclosure.

Referring to FIGS. 17 and 18, the processor 91 according to an embodiment may identify whether a washing process of the mop 160 is completed after the robot cleaner 10 returns to the station 20. For example, the processor 91 may identify that the washing process of the mop 160 is completed based on receiving a mop washing process completion signal from the station 20 via the communication interface 182.

The processor 91 according to an embodiment of the disclosure may control the motion driver 120 to allow the robot cleaner 10 to resume cleaning after the washing process of the mop 160 is completed.

For example, the processor 91 may control the motion driver 120 to move the robot cleaner 10 to the position at which the liquid was detected based on the completion of the washing process of the mop 160. In this instance, the processor 91 may determine the shortest distance (e.g., ds1 in FIG. 17) between the current position of the robot cleaner 10 (i.e., the position of the station 20) and the position at which the liquid was detected. In other words, the processor 91 may move the robot cleaner 10 back to the position at which the liquid was detected along the shortest path ds1 that was traveled when the robot cleaner 10 returned to the station 20.

As another example, the processor 91 may control the motion driver 120 to move the robot cleaner 10 to a cleaning area closest to the station 20 based on the completion of the washing process of the mop 160. In this instance, the cleaning area (e.g., S2 in FIG. 18) to which the robot cleaner 10 moves, which is closest to the station 20, may be one of the cleaning areas located adjacent to the station 20, excluding the cleaning area (e.g., S1 in FIG. 18) where the robot cleaner 10 performed cleaning before returning to the station 20. For example, the processor 91 may control the motion driver 120 to clean another cleaning area (e.g., S2 in FIG. 18) other than the cleaning area (e.g., S1 in FIG. 18) where liquid was detected after returning to the station 20 and completing the washing of the mop 160. According to an embodiment of the disclosure, the robot cleaner 10 may increase cleaning efficiency by reducing unnecessary traveling time and power consumption for traveling.

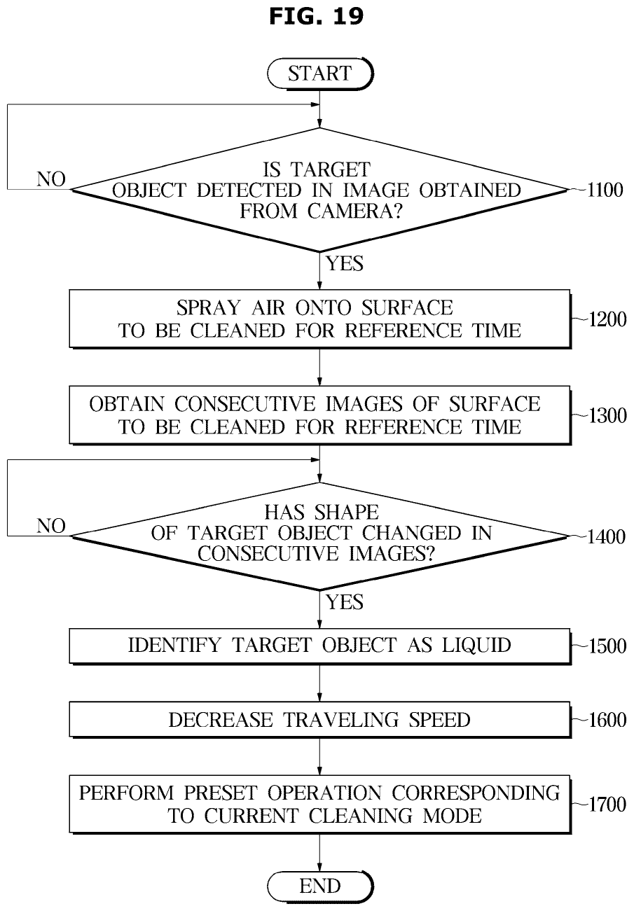

FIG. 19 is a flowchart illustrating a method for controlling a robot cleaner according to an embodiment of the disclosure.

Referring to FIG. 19, the processor 91 according to an embodiment may identify whether a target object is detected in an image obtained from the camera 171 at operation 1100. Identifying whether a target object is detected in the image obtained from the camera 171 may include determining whether the image obtained from the camera 171 includes the shape of the target object. In this instance, the target object may refer to an object on a surface to be cleaned, which may later be identified as liquid.

The camera 171 may obtain visual information about the surrounding environment of the robot cleaner 10. For example, the camera 171 may obtain an image of the surface to be cleaned. The image obtained from the camera 171 may be transmitted to the processor 91. The processor 91 may preprocess the image, extract features from the image, and identify whether the shape of the target object is included in the image based on the extracted features.

In this instance, when it is identified that the target object is detected in the image of the surface to be cleaned, the processor 91 may obtain position data of the target object (e.g., the target object is located in the kitchen) and/or distance data between the robot cleaner 10 and the shape of the target object from at least one sensor included in the sensor portion 170.

In a case where the target object is detected in the image obtained from the camera 171 (Yes in operation 1100), the processor 91 may control the air jet device 190 to spray air onto the surface to be cleaned for a reference time at operation 1200. In this instance, the processor 91 may control the motion driver 120 to move the robot cleaner toward the target object while spraying air toward the target object.

The processor 91 may obtain consecutive images of the surface to be cleaned for the reference time at operation 1300. In this instance, the consecutive images may correspond to a plurality of images obtained for the same object at a preset unit time interval. The consecutive images of the surface to be cleaned may include consecutive images of the forward cleaning surface of the robot cleaner 10.

The processor 91 may identify whether the shape of the target object in the obtained consecutive images changes at operation 1400. For example, the processor 91 may identify the target object as liquid based on the contour change of the target object S included in the consecutive images. In other words, the processor 91 may identify that liquid exists on the surface to be cleaned based on the contour change of the target object S included in the consecutive images. As another example, the processor 91 may identify the target object as liquid based on the surface state change of the target object S included in the consecutive images. In other words, the processor 91 may identify that liquid exists on the surface to be cleaned based on the surface state change of the target object included in the consecutive images.

In a case where the shape of the target object in the consecutive images changes (Yes in operation 1400), the processor 91 may identify the target object as liquid at operation 1500.

Based on identifying the target object as liquid, the processor 91 may control the motion driver 120 to decrease a traveling speed of the robot cleaner 10, and control the driver 150 to allow the robot cleaner to perform a preset operation corresponding to the current cleaning mode. In this instance, the cleaning mode of the robot cleaner 10 may include at least one of at least one of a dry cleaning mode, a wet cleaning mode, or a dry-and-wet cleaning mode.

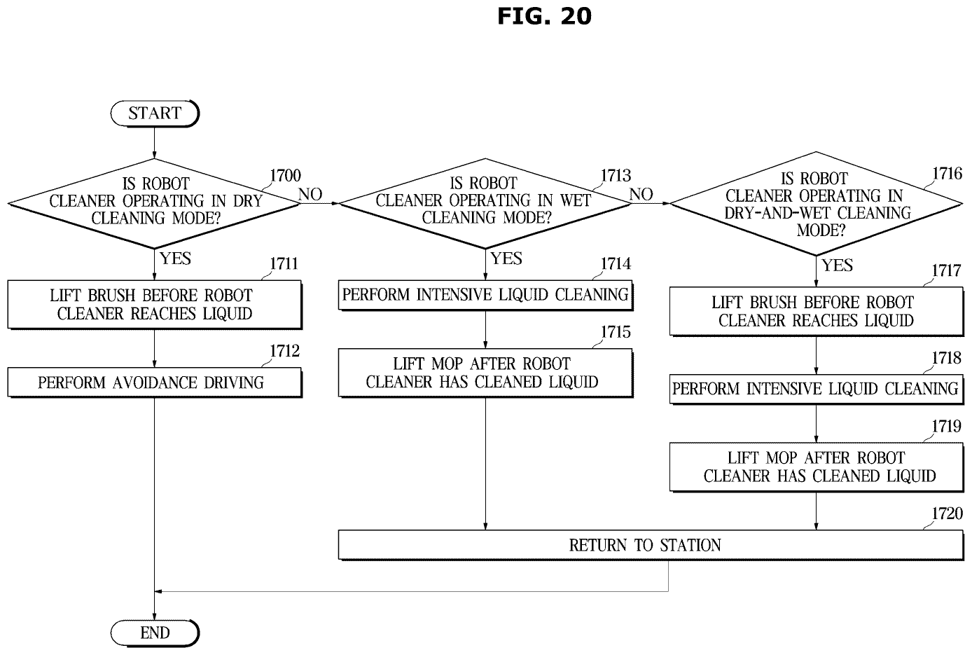

FIG. 20 is a flowchart illustrating preset operations performed according to a cleaning mode after a robot cleaner detects liquid according to an embodiment of the disclosure.

Referring to FIG. 20, according to an embodiment of the disclosure, the processor 91 may identify whether the robot cleaner 10 is currently operating in a dry cleaning mode at operation 1700.

In a case where the robot cleaner 10 is currently operating in the dry cleaning mode (Yes in operation 1700), the processor 91 may control the brush lifting driver 1512 to lift the brush 130 before the robot cleaner 10 reaches the liquid at operation 1711. For example, the brush 130 may be spaced apart from the surface to be cleaned. Accordingly, the robot cleaner 10 may prevent the brush 130 from being contaminated by the liquid.

Afterwards, the processor 91 may control the motion driver 120 to perform liquid avoidance driving to prevent the robot cleaner 10 from reaching the liquid at operation 1712. In this instance, the liquid avoidance driving may include changing the existing traveling path and traveling in a direction in which the robot cleaner 10 does not contact or pass through the liquid. Accordingly, the robot cleaner 10 will not be located at the position at which the liquid exists.

In a case where the robot cleaner 10 is not currently operating in the dry cleaning mode (No in operation 1700), the processor 91 may identify whether the robot cleaner 10 is currently operating in a wet cleaning mode at operation 1713.

In a case where the robot cleaner 10 is currently operating in the wet cleaning mode (Yes in operation 1713), the processor 91 may control at least one of the motion driver 120 or the mop rotation driver 1521 to allow the robot cleaner 10 to perform intensive liquid cleaning when the robot cleaner 10 reaches the liquid at operation 1714. Accordingly, when the robot cleaner 10 reaches the liquid, the brush 130 may be spaced apart from the surface to be cleaned, and the mop 160 may be in contact with the surface to be cleaned.

For example, the processor 91 may control the motion driver 120 to move the robot cleaner 10 to the position at which the liquid is identified as existing to perform intensive liquid cleaning. For example, the processor 91 may control the motion driver 120 to allow the robot cleaner 10 to perform a spiral drive or a forward-and-backward repetitive drive at the position at which the liquid is identified as existing. Accordingly, the robot cleaner 10 may repeatedly pass through the position at which the liquid exists, thereby increasing the contact frequency between the liquid and the mop 160 and improving the liquid removal efficiency. As another example, the processor 91 may control the mop rotation driver 1521 to increase or decrease a rotation speed of the mop 160, based on the robot cleaner 10 being moved to the position at which the liquid is identified as existing to perform intensive liquid cleaning.

As the rotation speed of the mop 160 increases, the contact frequency between the liquid and the mop 160 may be increased, thereby improving the liquid removal efficiency. In addition, as the frictional force between the mop 160 and the surface to be cleaned increases, viscous liquid may also be wiped off, and thus the liquid removal efficiency may be improved.

As the rotation speed of the mop 160 decreases, the mop 160 may sufficiently absorb the liquid, thereby improving the liquid removal efficiency.

Afterwards, based on the intensive liquid cleaning being completed, the processor 91 may control the mop lifting driver 1522 to lift the mop 160 to prevent the mop 160 from contacting the surface to be cleaned at operation 1715. Accordingly, the surface to be cleaned may be prevented from being contaminated by the used mop 160 or the contaminated water contained in the mop 160.

According to various embodiments of the disclosure, after performing the intensive liquid cleaning, the processor 91 may control the robot cleaner 10 to perform a process for identifying whether the liquid has been removed by the mop 160. For example, the processor 91 may identify whether an image obtained from the camera 171 after performing the intensive liquid cleaning includes the shape of the target object. In this instance, the processor 91 may control the motion driver 120 to move the robot cleaner 10 to obtain an image of the position at which the liquid was identified as existing. In a case where the image obtained after performing the intensive liquid cleaning does not include the target object, the processor 91 may identify that the liquid has been removed from the surface to be cleaned.

Afterwards, the processor 91 may control the motion driver 120 to return the robot cleaner 10 to the station 20 after completing the intensive liquid cleaning at operation 1720. In this instance, the processor 91 may control the motion driver 120 to travel on a path that avoids a soft floor while the robot cleaner 10 is returning to the station 20. For example, the processor 91 may identify whether a forward cleaning surface of the robot cleaner 10 corresponds to a soft floor, based on information about the forward cleaning surface obtained from the floor detection sensor 172. Based on identifying that the forward cleaning surface corresponds to a soft floor, the processor 91 may control the motion driver 120 to change the path. As another example, the processor 91 may determine a traveling path from the current position of the robot cleaner 10 to the station 20 without passing through a soft floor, based on the cleaning map M stored in the memory 92 and surface characteristics of an area to be cleaned included in the cleaning map M. Accordingly, the processor 91 may control the motion driver 120 to allow the robot cleaner 10 to travel based on the determined traveling path.

In a case where the robot cleaner 10 is not currently operating in the wet cleaning mode (No in operation 1713), the processor 91 may identify whether the robot cleaner 10 is currently operating in a dry-and-wet cleaning mode at operation 1716.

In a case where the robot cleaner 10 is currently operating in the dry-and-wet cleaning mode (Yes in operation 1716), based on identifying that liquid exists on the surface to be cleaned, the processor 91 may control the brush lifting driver 1512 to lift the brush 130 before the robot cleaner 10 reaches the liquid at operation 1717. For example, the brush 130 may be spaced apart from the surface to be cleaned. Accordingly, the robot cleaner 10 may prevent the brush 130 from being contaminated by the liquid.

In addition, the processor 91 may control at least one of the motion driver 120 or the mop rotation driver 1521 to allow the robot cleaner 10 to perform intensive liquid cleaning when the robot cleaner 10 reaches the liquid at operation 1718. Accordingly, when the robot cleaner 10 reaches the liquid, the brush 130 may be spaced apart from the surface to be cleaned, and the mop 160 may be in contact with the surface to be cleaned.

For example, the processor 91 may control the motion driver 120 to move the robot cleaner 10 to the position at which the liquid is identified as existing to perform intensive liquid cleaning. For example, the processor 91 may control the motion driver 120 to allow the robot cleaner 10 to perform a spiral drive or a forward-and-backward repetitive drive at the position at which the liquid is identified as existing. Accordingly, the robot cleaner 10 may repeatedly pass through the position at which the liquid exists, thereby increasing the contact frequency between the liquid and the mop 160 and improving the liquid removal efficiency. As another example, the processor 91 may control the mop rotation driver 1521 to increase or decrease a rotation speed of the mop 160, based on the robot cleaner 10 being moved to the position at which the liquid is identified as existing to perform intensive liquid cleaning. As the rotation speed of the mop 160 increases, the contact frequency between the liquid and the mop 160 may be increased, thereby improving the liquid removal efficiency. In addition, as the frictional force between the mop 160 and the surface to be cleaned increases, viscous liquid may also be wiped off, and thus the liquid removal efficiency may be improved.

As the rotation speed of the mop 160 decreases, the mop 160 may sufficiently absorb the liquid, thereby improving the liquid removal efficiency.

Afterwards, the processor 91 may control the mop lifting driver 1522 to lift the mop 160 to prevent the mop 160 from contacting the surface to be cleaned after completing the intensive liquid cleaning at operation 1719. Accordingly, the surface to be cleaned may be prevented from being contaminated by the used mop 160 or the contaminated water contained in the mop 160.

According to various embodiments of the disclosure, after performing the intensive liquid cleaning, the processor 91 may control the robot cleaner 10 to perform a process for identifying whether the liquid has been removed by the mop 160. For example, the processor 91 may identify whether an image obtained from the camera 171 after performing the intensive liquid cleaning includes the shape of the target object. In this instance, the processor 91 may control the motion driver 120 to move the robot cleaner 10 to obtain an image of the position at which the liquid was identified as existing. In a case where the image obtained after performing the intensive liquid cleaning does not include the target object, the processor 91 may identify that the liquid has been removed from the surface to be cleaned.

Afterwards, the processor 91 may control the motion driver 120 to return the robot cleaner 10 to the station 20 after completing the intensive liquid cleaning. In this instance, the processor 91 may control the motion driver 120 to travel on a path that avoids a soft floor while the robot cleaner 10 is returning to the station 20. For example, the processor 91 may identify whether a forward cleaning surface of the robot cleaner 10 corresponds to a soft floor, based on information about the forward cleaning surface obtained from the floor detection sensor 172. Based on identifying that the forward cleaning surface corresponds to a soft floor, the processor 91 may control the motion driver 120 to change the path. As another example, the processor 91 may determine a traveling path from the current position of the robot cleaner 10 to the station 20 without passing through a soft floor, based on the cleaning map M stored in the memory 92 and surface characteristics of an area to be cleaned included in the cleaning map M. Accordingly, the processor 91 may control the motion driver 120 to allow the robot cleaner 10 to travel based on the determined traveling path.

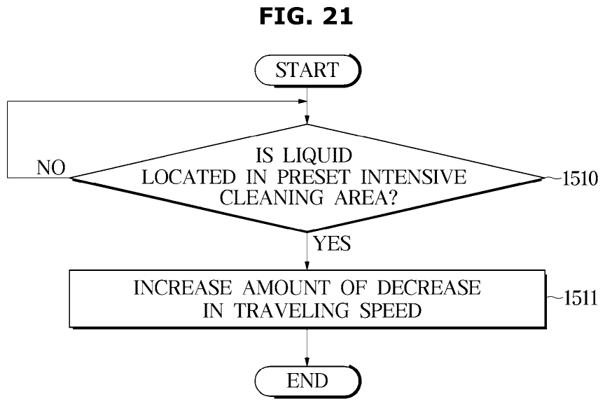

FIG. 21 is a flowchart illustrating operations of a robot cleaner according to a cleaning area where liquid is detected according to an embodiment of the disclosure.

Referring to FIG. 21, according to an embodiment of the disclosure, based on identifying that liquid exists on the surface to be cleaned, the processor 91 may control an operation of the robot cleaner 10 according to the cleaning area where liquid is detected.

According to an embodiment of the disclosure, the processor 91 may identify whether the liquid is located in a preset intensive cleaning area at operation 1510. In this instance, the intensive cleaning area may include a cleaning area where liquid is highly likely to be present on the surface to be cleaned due to the characteristics of the cleaning area (e.g., bathroom, kitchen, or the like). The cleaning map M may include information about the intensive cleaning area.

In a case where the liquid is located in the preset intensive cleaning area (Yes in operation 1510), the processor 91 may control the motion driver 120 to increase the amount of decrease in the traveling speed at operation 1511. Accordingly, the robot cleaner 10 according to an embodiment may reduce the contamination of the robot cleaner 10 or the re-contamination of the surface to be cleaned by the liquid on the surface to be cleaned.

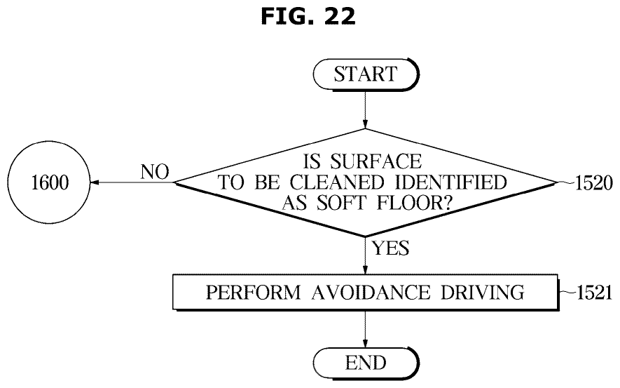

FIG. 22 is a flowchart illustrating operations of a robot cleaner according to characteristics of a surface to be cleaned according to an embodiment of the disclosure.

Referring to FIG. 22, according to an embodiment of the disclosure, based on identifying that liquid exists on the surface to be cleaned, the processor 91 may control an operation of the robot cleaner 10 according to characteristics of the surface to be cleaned.

According to an embodiment of the disclosure, the processor 91 may identify whether the surface to be cleaned with which the robot cleaner 10 is in contact corresponds to a soft floor, based on information obtained from the floor detection sensor 172 at operation 1520. In this instance, the soft floor may include a carpet, a rug, or a rubber mat. A hard floor may include a wooden floor, a tile floor, or a concrete floor. The examples of the soft floor or the hard floor are not limited to the aforementioned examples, and a soft and cushiony floor surface may be included in the soft floor, and a floor surface made of a solid and hard material may be included in the hard floor.

Based on identifying that the surface to be cleaned with which the robot cleaner 10 is in contact does not correspond to a soft floor based on the information obtained from the floor detection sensor 172 (No in operation 1520), the processor 91 may control the motion driver 120 to decrease a traveling speed at operation 1600, and control the driver 150 to allow the robot cleaner to perform a preset operation corresponding to the current cleaning mode at operation 1700.

On the other hand, based on identifying that the surface to be cleaned with which the robot cleaner 10 is in contact corresponds to a soft floor based on the information obtained from the floor detection sensor 172 (Yes in operation 1520), the processor 91 may control the motion driver 120 to perform liquid avoidance driving at operation 1521. The liquid avoidance driving may include changing the existing traveling path and traveling in a direction in which the robot cleaner 10 does not contact or pass through the liquid. Accordingly, the robot cleaner 10 will not be located at the position at which the liquid exists.

For a soft floor, such as a carpet, performing an intensive liquid cleaning process using the mop 160 may reduce the cleaning efficiency of the liquid and may instead cause the contamination to spread. Accordingly, the spread of contamination may be prevented by avoidance driving.

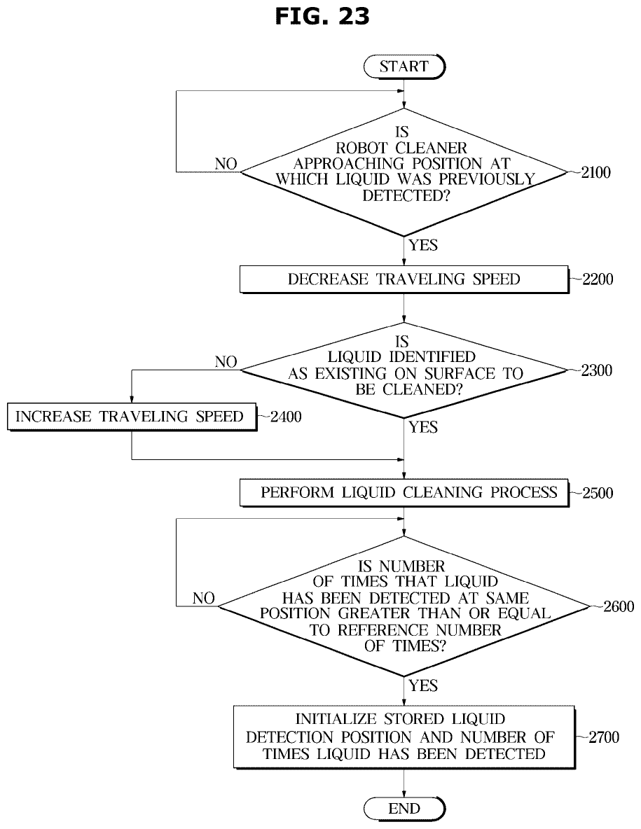

FIG. 23 is a flowchart illustrating operations of a robot cleaner according to a user's behavior pattern (user's usage pattern) according to an embodiment of the disclosure.

Referring to FIG. 23, the processor 91 according to an embodiment may control an operation of the robot cleaner 10 based on a user's behavior pattern.

Due to a user's job, lifestyle, and the like, liquid may repeatedly fall on the same position of a surface to be cleaned or in the same cleaning area. According to an embodiment of the disclosure, the cleaning map M stored in the memory 92 may include information about a liquid detection history.

According to an embodiment of the disclosure, the processor 91 may identify whether the robot cleaner 10 is approaching a position at which liquid was detected in the past at operation 2100. For example, the processor 91 may identify whether the robot cleaner 10 is approaching a position at which liquid was detected in the past based on the cleaning map M stored in the memory 92, by comparing the stored liquid detection history with the current position and traveling speed of the robot cleaner 10.

In a case where the robot cleaner 10 is approaching the position at which liquid was detected in the past (Yes in operation 2100), the processor 91 may control the motion driver 120 to decrease a traveling speed at operation 2200. Because liquid is likely to be present again at the position at which liquid has been detected in the past due to the user's behavior pattern, contamination by liquid may be prevented by decreasing the traveling speed before identifying whether liquid is present on the surface to be cleaned.

The processor 91 may identify whether liquid is present on the surface to be cleaned at operation 2300. In this instance, the method by which the processor 91 identifies whether liquid exists on the surface to be cleaned may be the same as the operations 1100 to 1500 described with reference to FIG. 19.

Based on identifying that no liquid is present on the surface to be cleaned (No in operation 2300), the processor 91 may control the motion driver 120 to increase the traveling speed at operation 2400.

On the other hand, based on identifying that liquid is present on the surface to be cleaned (Yes in operation 2300), the processor 91 may perform a liquid cleaning process at operation 2500. In this instance, performing the liquid cleaning process may include performing a preset operation corresponding to the current cleaning mode. In this instance, the preset operation corresponding to each cleaning mode (dry cleaning mode, wet cleaning mode, dry-and-wet cleaning mode) may include the operations described with reference to FIG. 20.

Afterwards, the processor 91 may identify whether the number of times that liquid has been detected at the same position is greater than or equal to a reference number of times at operation 2600. The reference number of times may be preset and stored in the memory 92. In addition, the reference number of times may be set or changed based on a user input received via the user interface 181.

Based on the number of times liquid has been detected at the same position being greater than or equal to the reference number of times (Yes in operation 2600), the processor 91 may initialize the liquid detection position and number of times liquid has been detected stored in the memory 92 at operation 2700. Initializing the liquid detection position and number of times liquid has been detected may include deleting information about a past detection position or information about the number of times liquid has been detected at each position from the memory 92. For example, in a case where liquid is identified as existing on the surface to be cleaned, the robot cleaner 10 is highly likely to perform a liquid cleaning process to remove the liquid. Accordingly, when liquid is detected a predetermined number of times at a position at which liquid has been detected in the past, the processor 91 may identify that the liquid removal has already been completed and initialize the stored liquid detection position and number of times liquid has been detected.

In accordance with an embodiment of the disclosure, a cleaning apparatus may include: a robot cleaner including a brush configured to scatter dirt by scrubbing a surface to be cleaned and a mop configured to clean the surface to be cleaned by contacting the surface to be cleaned, and a station on which the robot cleaner is placeable, wherein the robot cleaner may further include: an air jet device configured to spray air onto the surface to be cleaned, a camera configured to obtain an image of the surface to be cleaned, and a processor configured to determine to spray air onto the surface to be cleaned through the air jet device based on the image obtained from the camera, and identify a target object as liquid based on a shape change of the target object included in consecutive images obtained from the camera while the air jet device sprays air onto the surface to be cleaned.

The robot cleaner may further include a motion driver configured to move the robot cleaner, and the processor may be configured to control the motion driver to decrease a traveling speed of the robot cleaner based on identifying the target object as liquid.

The robot cleaner may further include a driver including a brush lifting driver configured to lift or lower the brush, a brush rotation driver configured to rotate the brush, a mop lifting driver configured to lift or lower the mop, and a mop rotation driver configured to rotate the mop, the processor may be configured to control the driver to allow the robot cleaner to perform a preset operation corresponding to a cleaning mode being performed, and the cleaning mode may include at least one of a dry cleaning mode, a wet cleaning mode, or a dry-and-wet cleaning mode.

The processor may be configured to control the brush lifting driver to lift the brush before the robot cleaner reaches the liquid, based on the robot cleaner operating in the dry cleaning mode.

The processor may be configured to control the motion driver to allow the robot cleaner to perform liquid avoidance driving to prevent the robot cleaner from reaching the liquid, based on the robot cleaner operating in the dry cleaning mode.

The processor may be configured to control at least one of the motion driver or the mop rotation driver to allow the robot cleaner to perform intensive cleaning of the liquid, based on the robot cleaner operating in the wet cleaning mode.

The processor may be configured to control the motion driver to move the robot cleaner to a position at which the liquid is identified as existing, and to allow the robot cleaner to perform a spiral drive or a forward-and-backward repetitive drive at the position at which the liquid is identified as existing, to perform intensive cleaning of the liquid.

The processor may be configured to control the mop rotation driver to increase a rotation speed of the mop, based on the robot cleaner being moved to the position at which the liquid is identified as existing to perform intensive cleaning of the liquid.

The processor may be configured to control the mop rotation driver to increase or decrease a rotation speed of the mop, based on the robot cleaner being moved to the position at which the liquid is identified as existing to perform intensive cleaning of the liquid.

The processor may be configured to control the motion driver to return the robot cleaner to the station after completing intensive cleaning of the liquid.

Based on the robot cleaner operating in the dry-and-wet cleaning mode, the processor may be configured to control the brush lifting driver to lift the brush before the robot cleaner reaches the liquid, control at least one of the motion driver or the mop rotation driver to allow the robot cleaner to perform intensive cleaning of the liquid, and control the motion driver to return the robot cleaner to the station after completing intensive cleaning of the liquid.

The robot cleaner may further include memory configured to store a cleaning map and information about at least one cleaning area which is a divided area, included in the cleaning map, and corresponds to a range in which a single cleaning cycle is completed, and the processor may be configured to identify whether a washing process of the mop is completed after the robot cleaner returns to the station, and control the motion driver to move the robot cleaner to a position at which the liquid is identified as existing or to a cleaning area closest to the station, based on the washing process of the mop being completed.

The robot cleaner may further include a driver including a brush lifting driver configured to lift or lower the brush, a brush rotation driver configured to rotate the brush, a mop lifting driver configured to lift or lower the mop, and a mop rotation driver configured to rotate the mop, and a floor detection sensor configured to obtain information about characteristics of the surface to be cleaned with which the robot cleaner is in contact, and the processor may be configured to identify whether the surface to be cleaned with which the robot cleaner is in contact corresponds to a soft floor, based on the information obtained from the floor detection sensor, and control the motion driver to allow the robot cleaner to perform liquid avoidance driving to prevent the robot cleaner from reaching the liquid, based on identifying that the surface to be cleaned corresponds to the soft floor.

In accordance with an embodiment of the disclosure, a cleaning apparatus may include: a robot cleaner including a brush configured to scatter dirt by scrubbing a surface to be cleaned and a mop configured to clean the surface to be cleaned by contacting the surface to be cleaned, and a station on which the robot cleaner is placeable, wherein the robot cleaner may further include: an air jet device configured to spray air onto the surface to be cleaned, a camera configured to obtain an image of the surface to be cleaned, and a processor configured to determine to spray air onto the surface to be cleaned through the air jet device based on the image obtained from the camera, and identify a target object as liquid based on a shape change of the target object included in consecutive images obtained from the camera before the air jet device sprays air onto the surface to be cleaned and after the air jet device completes spraying air onto the surface to be cleaned.

In accordance with an embodiment of the disclosure, in a method for controlling a cleaning apparatus including a robot cleaner including a brush configured to scatter dirt by scrubbing a surface to be cleaned, a mop configured to clean the surface to be cleaned by contacting the surface to be cleaned, an air jet device configured to spray air onto the surface to be cleaned, and a camera configured to obtain an image of the surface to be cleaned, and a station on which the robot cleaner is placeable, the method may include: determining to spray air onto the surface to be cleaned through the air jet device based on the image obtained from the camera, spraying, by the air jet device, air onto the surface to be cleaned, obtaining, by the camera, consecutive images of the surface to be cleaned while air is sprayed onto the surface to be cleaned, and identifying a target object as liquid based on a shape change of the target object included in the consecutive images obtained from the camera.

The robot cleaner may further include a motion driver configured to move the robot cleaner, and the method may further include controlling the motion driver to decrease a traveling speed of the robot cleaner based on identifying the target object as liquid.

The robot cleaner may further include a driver including a brush lifting driver configured to lift or lower the brush, a brush rotation driver configured to rotate the brush, a mop lifting driver configured to lift or lower the mop, and a mop rotation driver configured to rotate the mop, the method may further include: controlling the driver to allow the robot cleaner to perform a preset operation corresponding to a cleaning mode being performed, and the cleaning mode may include at least one of a dry cleaning mode, a wet cleaning mode, or a dry-and-wet cleaning mode.

The controlling of the driver to allow the robot cleaner to perform a preset operation corresponding to a cleaning mode being performed may include controlling the brush lifting driver to lift the brush before the robot cleaner reaches the liquid, based on the robot cleaner operating in the dry cleaning mode.

The controlling of the driver to allow the robot cleaner to perform a preset operation corresponding to a cleaning mode being performed may include controlling the motion driver to allow the robot cleaner to perform liquid avoidance driving to prevent the robot cleaner from reaching the liquid, based on the robot cleaner operating in the dry cleaning mode.

The controlling of the driver to allow the robot cleaner to perform a preset operation corresponding to a cleaning mode being performed may include controlling at least one of the motion driver or the mop rotation driver to allow the robot cleaner to perform intensive cleaning of the liquid, based on the robot cleaner operating in the wet cleaning mode.

The controlling of the driver to allow the robot cleaner to perform a preset operation corresponding to a cleaning mode being performed may include controlling the motion driver to return the robot cleaner to the station after completing intensive cleaning of the liquid.

The controlling of the driver to allow the robot cleaner to perform a preset operation corresponding to a cleaning mode being performed may include controlling the brush lifting driver to lift the brush before the robot cleaner reaches the liquid, controlling at least one of the motion driver or the mop rotation driver to allow the robot cleaner to perform intensive cleaning of the liquid, and controlling the motion driver to return the robot cleaner to the station after completing intensive cleaning of the liquid.

The cleaning apparatus and the method for controlling the same may improve liquid detection performance on a surface to be cleaned.

The cleaning apparatus and the method for controlling the same may accurately detect liquid on a surface to be cleaned, and control components of the cleaning apparatus according to a current cleaning mode, thereby improving cleaning efficiency and preventing re-contamination by the liquid.

The cleaning apparatus and the method for controlling the same may control components of the cleaning apparatus according to characteristics of a cleaning area, a user, or a surface to be cleaned, thereby improving cleaning efficiency and preventing re-contamination by the liquid.

Technical aspects that may be achieved by the disclosure are not limited to the above-mentioned aspects, and other technical aspects not mentioned will be clearly understood by one of ordinary skill in the technical art to which the disclosure belongs from the following description.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments.

The machine-readable recording medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the ‘non-transitory storage medium’ may include a buffer that temporarily stores data.

The methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as memory of a server of a manufacturer, a server of an application store, or a relay server.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A cleaning apparatus comprising:
a robot cleaner comprising a brush configured to scatter dirt by scrubbing a surface to be cleaned and a mop configured to clean the surface to be cleaned by contacting the surface to be cleaned; and
a station on which the robot cleaner is placeable,
wherein the robot cleaner further comprises:
an air jet device configured to spray air onto the surface to be cleaned,
a camera configured to obtain an image of the surface to be cleaned,
memory, comprising one or more storage media, storing instructions, and
a processor communicatively coupled to the air jet device, the camera, and the memory,
wherein the instructions, when executed by the processor, cause the robot cleaner to:
determine to spray air onto the surface to be cleaned through the air jet device based on the image obtained from the camera, and
identify a target object as liquid based on a shape change of the target object included in consecutive images obtained from the camera while the air jet device sprays air onto the surface to be cleaned.

2. The cleaning apparatus of claim 1,
wherein the robot cleaner further comprises a motion driver configured to move the robot cleaner, and
wherein the instructions, when executed by the processor, further cause the robot cleaner to control the motion driver to decrease a traveling speed of the robot cleaner based on identifying the target object as liquid.

3. The cleaning apparatus of claim 2,
wherein the robot cleaner further comprises a driver including a brush lifting driver configured to lift or lower the brush, a brush rotation driver configured to rotate the brush, a mop lifting driver configured to lift or lower the mop, and a mop rotation driver configured to rotate the mop,
wherein the instructions, when executed by the processor, further cause the robot cleaner to control the driver to allow the robot cleaner to perform a preset operation corresponding to a cleaning mode being performed, and
wherein the cleaning mode includes at least one of a dry cleaning mode, a wet cleaning mode, or a dry-and-wet cleaning mode.

4. The cleaning apparatus of claim 3, wherein the instructions, when executed by the processor, further cause the robot cleaner to control the brush lifting driver to lift the brush before the robot cleaner reaches the liquid, based on the robot cleaner operating in the dry cleaning mode.

5. The cleaning apparatus of claim 4, wherein the instructions, when executed by the processor, further cause the robot cleaner to control the motion driver to allow the robot cleaner to perform liquid avoidance driving to prevent the robot cleaner from reaching the liquid, based on the robot cleaner operating in the dry cleaning mode.

6. The cleaning apparatus of claim 3, wherein the instructions, when executed by the processor, further cause the robot cleaner to control at least one of the motion driver or the mop rotation driver to allow the robot cleaner to perform intensive cleaning of the liquid, based on the robot cleaner operating in the wet cleaning mode.

7. The cleaning apparatus of claim 6, wherein the instructions, when executed by the processor, further cause the robot cleaner to control the motion driver to move the robot cleaner to a position at which the liquid is identified as existing, and to allow the robot cleaner to perform a spiral drive or a forward-and-backward repetitive drive at the position at which the liquid is identified as existing, to perform intensive cleaning of the liquid.

8. The cleaning apparatus of claim 7, wherein the instructions, when executed by the processor, further cause the robot cleaner to control the mop rotation driver to increase a rotation speed of the mop, based on the robot cleaner being moved to the position at which the liquid is identified as existing to perform intensive cleaning of the liquid.

9. The cleaning apparatus of claim 6, wherein the instructions, when executed by the processor, further cause the robot cleaner to control the motion driver to return the robot cleaner to the station after completing intensive cleaning of the liquid.

10. The cleaning apparatus of claim 3, wherein, based on the robot cleaner operating in the dry-and-wet cleaning mode, the instructions, when executed by the processor, further cause the robot cleaner to:
control the brush lifting driver to lift the brush before the robot cleaner reaches the liquid,
control at least one of the motion driver or the mop rotation driver to allow the robot cleaner to perform intensive cleaning of the liquid, and
control the motion driver to return the robot cleaner to the station after completing intensive cleaning of the liquid.

11. The cleaning apparatus of claim 10,
wherein the robot cleaner further comprises memory configured to store a cleaning map and information about at least one cleaning area which is a divided area, included in the cleaning map, and corresponds to a range in which a single cleaning cycle is completed, and
wherein the instructions, when executed by the processor, further cause the robot cleaner to:
identify whether a washing process of the mop is completed after the robot cleaner returns to the station, and
control the motion driver to move the robot cleaner to a position at which the liquid is identified as existing or to a cleaning area closest to the station, based on the washing process of the mop being completed.

12. The cleaning apparatus of claim 2,
wherein the robot cleaner further comprises:
a driver including a brush lifting driver configured to lift or lower the brush, a brush rotation driver configured to rotate the brush, a mop lifting driver configured to lift or lower the mop, and a mop rotation driver configured to rotate the mop, and
a floor detection sensor configured to obtain information about characteristics of the surface to be cleaned with which the robot cleaner is in contact, and
wherein the instructions, when executed by the processor, further cause the robot cleaner to:
identify whether the surface to be cleaned with which the robot cleaner is in contact corresponds to a soft floor, based on the information obtained from the floor detection sensor, and
control the motion driver to allow the robot cleaner to perform liquid avoidance driving to prevent the robot cleaner from reaching the liquid, based on identifying that the surface to be cleaned corresponds to the soft floor.

13. A cleaning apparatus comprising:
a robot cleaner comprising a brush configured to scatter dirt by scrubbing a surface to be cleaned and a mop configured to clean the surface to be cleaned by contacting the surface to be cleaned; and
a station on which the robot cleaner is placeable,
wherein the robot cleaner further comprises:
an air jet device configured to spray air onto the surface to be cleaned,
a camera configured to obtain an image of the surface to be cleaned,
memory, comprising one or more storage media, storing instructions, and
a processor communicatively coupled to the air jet device, the camera, and the memory,
wherein the instructions, when executed by the processor, cause the robot cleaner to:
determine to spray air onto the surface to be cleaned through the air jet device based on the image obtained from the camera, and
identify a target object as liquid based on a shape change of the target object included in consecutive images obtained from the camera before the air jet device sprays air onto the surface to be cleaned and after the air jet device completes spraying air onto the surface to be cleaned.

14. A method for controlling a cleaning apparatus comprising a robot cleaner comprising a brush configured to scatter dirt by scrubbing a surface to be cleaned, a mop configured to clean the surface to be cleaned by contacting the surface to be cleaned, an air jet device configured to spray air onto the surface to be cleaned, and a camera configured to obtain an image of the surface to be cleaned, and a station on which the robot cleaner is placeable, the method comprising:
determining to spray air onto the surface to be cleaned through the air jet device based on the image obtained from the camera;
spraying, by the air jet device, air onto the surface to be cleaned;
obtaining, by the camera, consecutive images of the surface to be cleaned while air is sprayed onto the surface to be cleaned; and
identifying a target object as liquid based on a shape change of the target object included in the consecutive images obtained from the camera.

15. The method of claim 14,
wherein the robot cleaner further comprises a motion driver configured to move the robot cleaner, and
wherein the method further comprises controlling the motion driver to decrease a traveling speed of the robot cleaner based on identifying the target object as liquid.

16. The method of claim 15, further comprising:
controlling a driver inside the robot cleaner to allow the robot cleaner to perform a preset operation corresponding to a cleaning mode being performed,
wherein the driver includes a brush lifting driver configured to lift or lower the brush, a brush rotation driver configured to rotate the brush, a mop lifting driver configured to lift or lower the mop, and a mop rotation driver configured to rotate the mop, and
wherein the cleaning mode includes at least one of a dry cleaning mode, a wet cleaning mode, or a dry-and-wet cleaning mode.

17. The method of claim 16, further comprising controlling the brush lifting driver to lift the brush before the robot cleaner reaches the liquid, based on the robot cleaner operating in the dry cleaning mode.

18. The method of claim 17, further comprising controlling the motion driver to allow the robot cleaner to perform liquid avoidance driving to prevent the robot cleaner from reaching the liquid, based on the robot cleaner operating in the dry cleaning mode.
